(19) United States
(12) Patent Application Publication
(10) Pub. No.: US 2024/0275181 A1
(43) Pub. Date: Aug. 15, 2024

(54) METHOD OF CHARGING A RECHARGEABLE ELECTRICAL ENERGY STORAGE AND CHARGER CONTROLLER THEREOF

(71) Applicant: XNERGY AUTONOMOUS POWER TECHNOLOGIES PTE. LTD., Singapore (SG)

(72) Inventors: Longqi ZHANG, Singapore (SG); Luiz Rizki RAMELAN, Singapore (SG); Xiaolei HU, Singapore (SG)

(21) Appl. No.: 18/566,988

(22) PCT Filed: Jun. 4, 2021
(86) PCT No.: PCT/SG2021/050324

§ 371 Date: Dec. 4, 2023

(51) Int. Cl. H02J 7/00; H01M 10/44

(52) U.S. Cl. CPC H02J 7/00047; H01M 10/44; H02J 7/00036; H02J 7/00714; H02J 7/007182

(57) ABSTRACT

There is provided a method of charging a rechargeable electrical energy storage, including receiving, from a memory, for each of a plurality of charging stages of a charging profile for charging the rechargeable electrical energy storage, a set of charging parameters associated with the charging stage; and controlling, for the above-mentioned each of the plurality of charging stages of the charging profile, a charger coupled to the rechargeable electrical energy storage based on the corresponding set of charging parameters received for charging the rechargeable electrical energy storage. The memory includes charging profile data defining the charging profile for charging the rechargeable electrical energy storage, the charging profile data including a plurality of charging profile blocks defining the plurality of charging stages of the charging profile, respectively, and for the above-mentioned each of the plurality of charging stages of the charging profile, the set of charging parameters associated with the charging stage is obtained from the corresponding charging profile block of the charging profile data. There is also provided a corresponding charger controller for charging a rechargeable electrical energy storage, and a charging system including the charger controller.

### TECHNICAL FIELD

The present invention generally relates to a method of charging a rechargeable electrical energy storage, a charger controller for charging a rechargeable electrical energy storage and a charging system comprising the charger controller.

### BACKGROUND

Recent trends in electrification and automation in multiple sectors, such as electric vehicles, electric forklifts, robots, automated guided vehicles, have caused the proliferation of electrical energy storages, especially batteries. For example, there are various types of batteries, such as lead-acid, lithium-ion, lithium polymer, and so on. Different battery types may have different characteristics due to their different chemical properties, and may thus require different charging strategies in terms of charging current, charging voltage, and/or charging power in order to optimize the charging time, battery lifetime, and/or various safety aspects (e.g., accelerated battery degradation, overcharging, temperature rise, and over-voltage). Various conventional charging strategies have been developed in an attempt to achieve optimal charging, such as constant current (CC), constant voltage (CV) and constant current-constant voltage (CCCV). In addition, apart from the battery type, the battery size may also be a factor for determining the charging voltage and charging current. For example, the battery size may be defined by how many battery cells are used and the configuration of the battery cells. In this regard, battery cells arranged in parallel may increase the battery charging current, whereas battery cells arranged in series may increase battery voltage.

However, conventional electrical energy storage chargers (e.g., battery chargers) typically have a pre-configured specific charging strategy for a specific electrical energy storage type and size (e.g., for a specific battery type and size). Another type of conventional electrical energy storage chargers may have a pre-configured specific charging strategy which allows voltage and current references to be adjusted, thereby providing a certain degree of flexibility to charge different size of electrical energy storage, but at least the limitation of specific electrical energy storage type (e.g., specific battery type) still exists, such as limited to only being suitable for charging lead-acid batteries or only being suitable for charging lithium-ion batteries.

A need therefore exists to provide a method of charging a rechargeable electrical energy storage and a charger controller thereof, that seek to overcome, or at least ameliorate, one or more of the deficiencies of conventional methods or chargers for charging a rechargeable electrical energy storage, and more particularly, to enable and/or enhance flexibility in implementing charging strategies for supporting various (different) battery sizes and types. It is against this background that the present invention has been developed.

### SUMMARY

According to a first aspect of the present invention, there is provided a method of charging a rechargeable electrical energy storage, comprising:
receiving, from a memory, for each of a plurality of charging stages of a charging profile for charging the rechargeable electrical energy storage, a set of charging parameters associated with the charging stage; and
controlling, for said each of the plurality of charging stages of the charging profile, a charger coupled to the rechargeable electrical energy storage based on the corresponding set of charging parameters received for charging the rechargeable electrical energy storage, wherein
the memory comprises charging profile data defining the charging profile for charging the rechargeable electrical energy storage, the charging profile data comprising a plurality of charging profile blocks defining the plurality of charging stages of the charging profile, respectively, and
for said each of the plurality of charging stages of the charging profile, the set of charging parameters associated with the charging stage is obtained from the corresponding charging profile block of the charging profile data.

According to a second aspect of the present invention, there is provided a charger controller for charging a rechargeable electrical energy storage, the charger controller comprising:
a memory; and
at least one processor coupled to the memory and configured to:
   receive, from the memory, for each of the plurality of charging stages of a charging profile for charging the rechargeable electrical energy storage, a set of charging parameters associated with the charging stage; and
   control, for said each of the plurality of charging stages of the charging profile, a charger coupled to the rechargeable electrical energy storage based on the corresponding set of charging parameters received for charging the rechargeable electrical energy storage, wherein
the memory comprises charging profile data defining the charging profile for charging the rechargeable electrical energy storage, the charging profile data comprising a plurality of charging profile blocks defining the plurality of charging stages of the charging profile, respectively, and
for said each of the plurality of charging stages of the charging profile, the set of charging parameters associated with the charging stage is obtained from the corresponding charging profile block of the charging profile data.

According to a third aspect of the present invention, there is provided a charging system for charging a rechargeable electrical energy storage, the charging system comprising:
a charger coupled or couplable to the rechargeable electrical energy storage; and
a charger controller as described according to the second aspect of the present invention communicatively coupled to the charger and configured to control the charger for charging the rechargeable electrical energy storage.

According to a fourth aspect of the present invention, there is provided a computer program product, embodied in one or more computer-readable storage mediums, comprising instructions executable by at least one processor to perform the method of charging a rechargeable electrical energy storage as described according to the first aspect of the present invention.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic flow diagram of a method of charging a rechargeable electrical energy storage, according to various embodiments of the present invention;

FIG. 2 depicts a schematic block diagram of a charger controller for charging a rechargeable electrical energy storage, according to various embodiments of the present invention;

FIG. 3 depicts a schematic block diagram of a charging system for charging a rechargeable electrical energy storage, according to various embodiments of the present invention;

FIG. 4 depicts a schematic block diagram of an exemplary computer system in which the charger controller for charging a rechargeable electrical energy storage according to various embodiments of the present invention may be realized or implemented;

FIGS. 5A to 5C depict example charging profiles of the conventional constant current (CC) charging strategy, the conventional constant voltage (CV) charging strategy and the conventional constant current constant-voltage (CCCV) charging strategy, respectively;

FIGS. 6A to 6C depict example charging profiles of the conventional multi-stage CCCV charging strategy;

FIGS. 7A and 7B depict example charging profiles of the conventional IUIa and IUIUa charging strategies, respectively;

FIGS. 8A and 8B depict example charging profiles of the conventional Wa charging strategy and the conventional W0Wa charging strategy, respectively;

FIGS. 9A and 9B depict two example charging profiles for a supercapacitor;

FIG. 10 depicts a schematic block diagram of a conventional digital based charger;

FIG. 11A depicts a schematic block diagram (constant current control block diagram) of an example charger implemented based on a feedback controller configured for the constant current (CC) charging profile;

FIG. 11B depicts a schematic block diagram (constant voltage control block diagram) of an example charger implemented based on a feedback controller configured for the constant voltage (CV) charging profile;

FIG. 12A depicts a schematic block diagram (switched CCCV control block diagram) of an example charger implemented based on a feedback controller configured for the constant current constant voltage (CCCV) charging profile;

FIG. 12B depicts a schematic block diagram (series CCCV control block diagram) of another example charger implemented based on a feedback controller configured for another form of the CCCV charging configuration, which may be referred to as a series CCCV charging strategy, whereby the voltage and current regulators are cascaded in series;

FIG. 13 depicts a schematic block diagram of a conventional adjustable battery charger system;

FIG. 14 depicts a schematic block diagram of a charging system for charging a rechargeable electrical energy storage according to various example embodiments of the present invention;

FIG. 15A depicts a schematic drawing of an example database structure of a database according to various example embodiments of the present invention for a charging profile for charging a rechargeable battery;

FIG. 15B depicts a flowchart of a method of charging a rechargeable battery performed by an interpreter (charger controller), according to various example embodiments of the present invention;

FIGS. 16A to 16C depict schematic flow diagrams of example charging processes performed, including recurring charging strategies, based on charging profile blocks (CPBs), according to various example embodiments of the present invention;

FIGS. 17A and 17B depict an example IUIUa charging profile and the corresponding values of attributes of the charging parameters of the charging profile data, respectively, according to various example embodiments of the present invention;

FIGS. 18A and 18B depict an example five-step constant current charging profile and the corresponding values of attributes of the charging parameters of the charging profile data, respectively, according to various example embodiments of the present invention;

FIGS. 19A and 19B depict an example Wa charging profile with repeating equalizing stage and the corresponding values of attributes of the charging parameters of the charging profile data, respectively, according to various example embodiments of the present invention;

FIGS. 20A and 20B depict an example W0Wa charging profile with repeating equalizing stage and the corresponding values of attributes of the charging parameters of the charging profile data, respectively, according to various example embodiments of the present invention;

FIGS. 21A and 21B depict an example supercapacitor charging profile and the corresponding values of attributes of the charging parameters of the charging profile data, respectively, according to various example embodiments of the present invention; and

FIG. 22 depicts a graph showing the implementation of the five-step constant current charging profile obtained using the charging system according to various example embodiments of the present invention.

### DETAILED DESCRIPTION

Various embodiments of the present invention provide a method of charging a rechargeable electrical energy storage, a charger controller for charging a rechargeable electrical energy storage and a charging system comprising the charger controller. As mentioned in the background of the present invention, conventional electrical energy storage chargers typically have a pre-configured specific charging strategy for a specific electrical energy storage type and size, or may have a pre-configured specific charging strategy which allows voltage and current references to be adjusted. Accordingly, conventional electrical energy storage chargers may be limited to (e.g., may only be suitable or optimized for) charging a specific electrical energy storage type and size (according to the pre-configured specific charging strategy) or may at least be limited to (e.g., may only be suitable or optimized for) charging a specific electrical energy storage type (e.g., limited to only being suitable for charging lead-acid batteries or only being suitable for charging lithium-ion batteries). Accordingly, various embodiments of the present invention provide a method of charging a rechargeable electrical energy storage and a charger controller thereof, that seek to overcome, or at least ameliorate, one or more of the deficiencies of conventional methods or chargers for charging a rechargeable electrical energy storage, and more particularly, to enable and/or enhance flexibility in implementing charging strategies (which may also be referred to herein as charging techniques) for supporting various (different) electrical energy storage sizes and types.

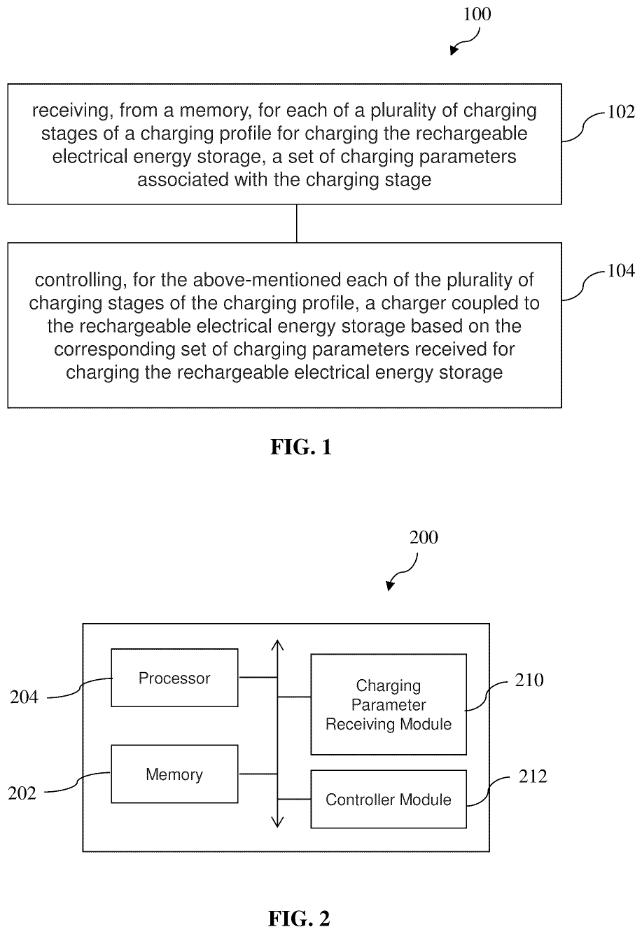

FIG. 1 depicts a schematic flow diagram of a method 100 of charging a rechargeable electrical energy storage, according to various embodiments of the present invention. The method 100 comprising: receiving (at 102), from a memory, for each of a plurality of charging stages of a charging profile for charging the rechargeable electrical energy storage, a set of charging parameters associated with the charging stage; and controlling (at 104), for the above-mentioned each of the plurality of charging stages of the charging profile, a charger coupled to the rechargeable electrical energy storage based on the corresponding set of charging parameters received for charging the rechargeable electrical energy storage. In particular, the memory comprises charging profile data defining the charging profile for charging the rechargeable electrical energy storage. The charging profile data comprises a plurality of charging profile blocks defining the plurality of charging stages of the charging profile, respectively. In this regard, for the above-mentioned each of the plurality of charging stages of the charging profile, the above-mentioned set of charging parameters associated with the charging stage is obtained from the corresponding charging profile block of the charging profile data.

It will be appreciated by a person skilled in the art that the rechargeable electrical energy storage may refer to any electrical energy storage configured to supply electrical energy that is rechargeable, such as but not limited to, any type of rechargeable battery or any type of rechargeable electrochemical capacitor (e.g., supercapacitor, which may also be referred to as an ultracapacitor). In various embodiments, more particularly, the rechargeable electrical energy storage may refer to a rechargeable battery (e.g., an alkaline battery, a lead acid battery, a lithium-ion battery, and so on) or a rechargeable electrochemical capacitor (e.g., supercapacitor). It will also be appreciated by a person skilled in the art that the rechargeable electrical energy storage may include one rechargeable electrical energy storage unit (e.g., one rechargeable battery or electrochemical capacitor) or a combination of rechargeable electrical energy storage units (e.g., a combination of rechargeable batteries or electrochemical capacitors).

In various embodiments, the charger may be coupled to the rechargeable electrical energy storage based on wired coupling (e.g., wires or conductors) or wireless coupling (e.g., wireless power transfer based on magnetic induction). In other words, the charger may be configured to charge the rechargeable electrical energy storage based on wired (conductive) charging or wireless (inductive) charging.

In various embodiments, the plurality of charging stages of the charging profile for charging the rechargeable electrical energy storage may relate to (e.g., cover or correspond to) the entire charging process for charging the rechargeable electrical energy storage. In various other embodiments, the plurality of charging stages may relate to (e.g., cover or correspond to) a portion or a part of the entire charging process for charging the rechargeable electrical energy storage.

Therefore, according to the method 100 of charging a rechargeable electrical energy storage, a charging profile for charging the rechargeable electrical energy storage is advantageously divided or segmented into a plurality of charging stages, and furthermore, there is advantageously provided charging profile data comprising a plurality of charging profile blocks stored in a memory, each charging profile block (comprising a set of charging parameters) defining the corresponding charging stage of the charging profile. Such a technical approach has advantageously been found to enable and/or enhance flexibility in configuring a charging profile for charging the rechargeable electrical energy storage, and thereby enabling and/or enhancing flexibility in implementing charging strategies for supporting various (different) electrical energy storage sizes and types. These and other advantages or technical effects will become more apparent to a person skilled in the art as the method 100 of charging a rechargeable electrical energy storage, as well as corresponding charger controller and charging system, are described in more detail according to various embodiments and example embodiments of the present invention.

In various embodiments, each of the plurality of charging profile blocks comprises a plurality of predefined charging parameter data fields. In this regard, each predefined charging parameter data field of the charging profile block is configurable with a corresponding charging parameter for defining the charging stage corresponding to the charging profile block. In various embodiments, a predefined charging parameter data field may be configured with a corresponding charging parameter by having stored or recorded therein the corresponding charging parameter. For example, the charging parameter may be defined by a value, such as a number, a character or a word.

In various embodiments, the above-mentioned each predefined charging parameter data field of the charging profile block is configurable with the corresponding charging parameter based on a corresponding user data input received via a data input user interface configured for receiving a user data input for defining the charging profile for charging the rechargeable electrical energy storage. Accordingly, each of the plurality of charging profile blocks is configured to be configurable by a user based on the corresponding user data input received via the data input user interface, thereby enabling the user to configure one or more of the plurality of charging profile blocks as desired or as appropriate for configuring or defining corresponding one or more charging stages of the charging profile for charging the rechargeable electrical energy storage. Accordingly, the charging profile for charging the rechargeable electrical energy storage can advantageously be configured as desired or as appropriate, such as to support a particular electrical energy storage size and type (e.g., suitable or optimized for the particular electrical energy storage size and type). It will be appreciated by a person skilled in the art that the present invention is not directed to determining the suitable or optimized charging profile (or the suitable or optimized set of charging parameters for each charging stage), but enables and/or enhances flexibility in configuring the charging profile for charging the rechargeable electrical energy storage, and thus, it is not necessary to describe the process of determining suitable or optimized charging profile herein.

In various embodiments, for the above-mentioned each of the plurality of charging profile blocks, the plurality of predefined charging parameter data fields of the charging profile block comprises: a first reference voltage parameter data field configured to store a first reference voltage parameter corresponding to a first reference voltage value for the charging stage corresponding to the charging profile block, and/or a first reference current parameter data field configured to store a first reference current parameter corresponding to a first reference current value for the charging stage corresponding to the charging profile block. That is, the plurality of predefined charging parameter data fields comprises at least one of the first reference voltage parameter data field and the first reference current parameter data field.

In various embodiments, the plurality of predefined charging parameter data fields of the charging profile block further comprises an index parameter field configured to store an index parameter corresponding to an index of a charging profile block of the plurality of charging profile blocks based on which the charging of the rechargeable electrical energy storage is to be performed at a next charging stage of the charging profile. In this regard, each of the plurality of charging profile blocks may have an associated index (e.g., indexed with a corresponding number). Accordingly, the index parameter field may be configured to store an index parameter (e.g., an index value) indicating the next charging profile block based on which the charging of the rechargeable electrical energy storage is to be performed at the next (immediately next) charging stage of the charging profile.

In various embodiments, the index parameter is an index loop parameter indicating the index of a preceding charging profile block of the plurality of charging profile blocks with respect to the charging profile block for forming a charging loop. In other words, the above-mentioned next charging profile block may be a preceding (or previous) charging profile block of the plurality of charging profile blocks with respect to (or relative to) the current charging profile block so as to form a charging loop. In various embodiments, a preceding (or previous) charging profile block with respect to (or relative to) a current charging profile block may refer to a charging profile block having an associated index with a lower value (e.g., a smaller index value).

In various embodiments, for the above-mentioned each of the plurality of charging profile blocks, the plurality of predefined charging parameter data fields of the charging profile block further comprises: a second reference voltage parameter data field configured to store a second reference voltage parameter corresponding to a second reference voltage value for the charging stage corresponding to the charging profile block, and/or a second reference current parameter data field configured to store a second reference current parameter corresponding to a second reference current value for the charging stage corresponding to the charging profile block. That is, the plurality of predefined charging parameter data fields further comprises at least one of the second reference voltage parameter data field and the second reference current parameter data field. In various embodiments, the first reference voltage value and the second reference voltage value define a start reference voltage value and an end reference voltage value, respectively, for the charging stage corresponding to the charging profile block, and the first reference current value and the second reference current value define a start reference current value and an end reference current value, respectively, for the charging stage corresponding to the charging profile block. By way of an example only and without limitations, for a charging profile block for a corresponding charging stage, the first reference voltage value and the first reference current voltage value may be an initial reference voltage value (e.g., corresponding to charging parameter “voltage_0” in example embodiments described later below) and an initial reference current value (e.g., corresponding to charging parameter “current_0” in example embodiments described later below), respectively, for the corresponding charging stage, and based on which the charger controller generates an output reference voltage value and an output reference current value for controlling the charger for the corresponding charging stage. By way of another example only and without limitations, for a charging profile block for a corresponding charging stage, the first reference voltage value and the first reference current voltage value may be an initial reference voltage value and an initial reference current value, respectively, and the second reference voltage value and the second reference current value may be a target reference voltage value (e.g., corresponding to charging parameter “voltage_1” in example embodiments described later below) and a target reference current value (e.g., corresponding to charging parameter “current_1” in example embodiments described later below), respectively, for the corresponding charging stage, and based on which the charger controller generates an output reference voltage value and an output reference current value for controlling the charger for the corresponding charging stage.

In various embodiments, for the above-mentioned each of the plurality of charging profile blocks, the plurality of predefined charging parameter data fields of the charging profile block further comprises a charging type parameter data field configured to store a charging type parameter corresponding to a charging type for the charging stage corresponding to the charging profile block. By way of examples only and without limitations, example charging types may include a constant charging type, a slope charging type, and so on. It will be appreciated to a person skilled in the art that the charging type may be any charging type (which may also be referred to as a charging strategy) as desired or as appropriate for charging a rechargeable electrical energy storage, and the present invention is not limited to any particular charging type(s) (or charging strategy) for charging a rechargeable electrical energy storage.

In various embodiments, for the above-mentioned each of the plurality of charging profile blocks, the plurality of predefined charging parameter data fields of the charging profile block further comprises: a cut-off current parameter data field configured to store a cut-off current parameter corresponding to a cut-off current value for the charging stage corresponding to the charging profile block; and/or a cut-off voltage parameter data field configured to store a cut-off voltage parameter corresponding to a cut-off voltage value for the charging stage corresponding to the charging profile block. That is, the plurality of predefined charging parameter data fields further comprises at least one of the cut-off current parameter data field and the cut-off voltage parameter data field.

In various embodiments, for the above-mentioned each of the plurality of charging stages, the corresponding set of charging parameters received associated with the charging stage comprises the charging type parameter. In this regard, the above-mentioned controlling (at 104), for the above-mentioned each of the plurality of charging stages, the charger comprises: generating, for the charging stage, an output reference voltage value and an output reference current value based on the charging type parameter in the corresponding set of charging parameters received associated with the charging stage; and supplying, for the charging stage, the output reference voltage value and the output reference current value generated to the charger.

In various embodiments, for at least a first charging stage of the plurality of charging stages, the corresponding set of charging parameters received further comprises the first reference voltage parameter and the first reference current parameter, and the charging type parameter of the corresponding set of charging parameters received corresponds to a constant charging type for the first charging stage. In this regard, the above-mentioned controlling (104) the charger comprises: generating, for the first charging stage, the output reference voltage value and the output reference current value based on the charging type parameter, the first reference voltage parameter and the first reference current parameter in the corresponding set of charging parameters received associated with the first charging stage; and supplying, for the first charging stage, the output reference voltage value and the output reference current value generated to the charger.

In various embodiments, for at least a second charging stage of the plurality of charging stages, the corresponding set of charging parameters received further comprises the first reference voltage parameter, the first reference current parameter, the second reference voltage parameter and the second reference voltage parameter, and the charging type parameter of the corresponding set of charging parameters received corresponds to a slope charging type for the second charging stage. In this regard, the above-mentioned controlling (at 104) the charger comprises: generating, for the second charging stage, the output reference voltage value and the output reference current value based on the charging type parameter, the first reference voltage parameter, the first reference current parameter, the second reference voltage parameter, and the second reference voltage parameter in the corresponding set of charging parameters received associated with the second charging stage; and supplying, for the second charging stage, the output reference voltage value and the output reference current value generated to the charger. It will be appreciated by a person skilled in the art that the designations “first” and “second” used in the above-mentioned first and second charging stages are used as a convenient way of distinguishing between two or more charging stages, and do not indicate any particular order of such charging stages. Moreover, it will be appreciated by a person skilled in the art that the first and second charging stages do not need to co-exist in the plurality of charging stages. In other words, for example, the first charging stage may be included in the plurality of charging stages without the second charging stage in an example, and the second charging stage may be included in the plurality of charging stages without the first charging stage in another example.

In various embodiments, in relation to or associated with the above-mentioned index parameter, each of the plurality of charging profile blocks of the charging profile data is associated with a corresponding index. In various embodiments, for the first or second charging stage (i.e., in the case of either the first charging stage or the second charging stage), the corresponding set of charging parameters received further comprises the index parameter, and the above-mentioned controlling (at 104) the charger comprises controlling, for the next charging stage of the charging profile, the charger to perform the charging of the rechargeable electrical energy storage based on the charging profile block of the plurality of charging profile blocks having the associated index corresponding to the index parameter.

In various embodiments, the above-mentioned controlling (at 104), for the above-mentioned each of the plurality of charging stages, the charger coupled to the rechargeable electrical energy storage, is further based on timing information generated by a timer.

FIG. 2 depicts a schematic block diagram of a charger controller 200 for charging a rechargeable electrical energy storage, according to various embodiments of the present invention. The charger controller 200 comprises: a memory 202; and at least one processor 204 coupled to the memory 202 and configured to: receive, from the memory 202, for each of a plurality of charging stages of a charging profile for charging the rechargeable electrical energy storage, a set of charging parameters associated with the charging stage; and control, for the above-mentioned each of the plurality of charging stages of the charging profile, a charger coupled to the rechargeable electrical energy storage based on the corresponding set of charging parameters received for charging the rechargeable electrical energy storage. In particular, the memory comprises charging profile data defining the charging profile for charging the rechargeable electrical energy storage. The charging profile data comprises a plurality of charging profile blocks defining the plurality of charging stages of the charging profile, respectively. In this regard, for the above-mentioned each of the plurality of charging stages of the charging profile, the above-mentioned set of charging parameters associated with the charging stage is obtained from the corresponding charging profile block of the charging profile data.

It will be appreciated by a person skilled in the art that the at least one processor 204 may be configured to perform the required functions or operations through set(s) of instructions (e.g., software modules) executable by the at least one processor 204 to perform the required functions or operations. Accordingly, as shown in FIG. 2, the charger controller 200 may further comprise a charging parameter receiving module (or a charging parameter receiving circuit) 210 configured to receive, from the memory 202, for each of a plurality of charging stages of a charging profile for charging the rechargeable electrical energy storage, a set of charging parameters associated with the charging stage, and a controller module (or a controller circuit) 212 configured to control, for the above-mentioned each of the plurality of charging stages of the charging profile, a charger coupled to the rechargeable battery based on the corresponding set of charging parameters received for charging the rechargeable electrical energy storage.

It will be appreciated by a person skilled in the art that the above-mentioned modules are not necessarily separate modules, and two or more modules may be realized by or implemented as one functional module (e.g., a circuit or a software program) as desired or as appropriate without deviating from the scope of the present invention. For example, the charging parameter receiving module 210 and the controller module 212 may be realized (e.g., compiled together) as one executable software program (e.g., software application or simply referred to as an “app”), which for example may be stored in the memory 202 and executable by the at least one processor 204 to perform the functions/operations as described herein according to various embodiments.

In various embodiments, the charger controller 200 corresponds to the method 100 as described hereinbefore with reference to FIG. 1, therefore, various functions or operations configured to be performed by the at least one processor 204 described above may correspond to various steps of the method 100 described in further detail hereinbefore, and thus need not be repeated with respect to the charger controller 200 for clarity and conciseness. In other words, various embodiments described herein in context of the method 100 of charging a rechargeable electrical energy storage are analogously valid for the corresponding charger controller 200 for charging a rechargeable electrical energy storage, and vice versa.

For example, in various embodiments, the memory 202 may have stored therein the charging parameter receiving module 210 and/or the controller module 212, which respectively correspond to various steps of the method 100 as described hereinbefore according to various embodiments, which are executable by the at least one processor 204 to perform the corresponding functions/operations as described herein.

A computing system, a controller, a microcontroller or any other system providing a processing capability may be presented according to various embodiments in the present disclosure. Such a system may be taken to include one or more processors and one or more computer-readable storage mediums. For example, the charger controller 200 as described hereinbefore may include a processor 204 and a computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “controlling”, “generating”, “supplying” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (which may also be embodied as a device or an apparatus) for performing the operations/functions of the methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the invention. It will be appreciated by a person skilled in the art that various modules described herein (e.g., the charging parameter receiving module 210 and/or the controller module 212) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general-purpose computer. The computer program when loaded and executed on such a general-purpose computer effectively results in an apparatus that implements the steps of the methods described herein.

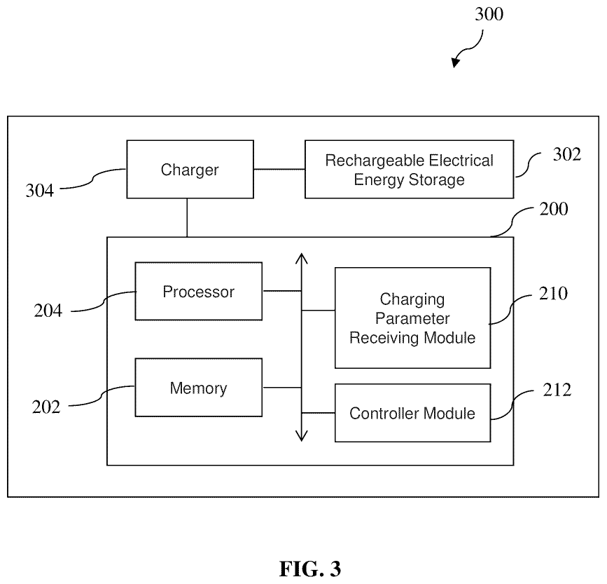

FIG. 3 depicts a schematic block diagram of a charging system 300 for charging a rechargeable electrical energy storage 302, according to various embodiments of the present invention. The charging system 300 comprises: a charger 304 coupled or couplable to the rechargeable electrical energy storage 302; and the charger controller 200 (as described hereinbefore according to various embodiments with reference to FIG. 2) communicatively coupled to the charger 304 and configured to control the charger 304 for charging the rechargeable electrical energy storage 302 (according to the method 100 of charging a rechargeable electrical energy storage as described hereinbefore according to various embodiments with reference to FIG. 1). In various embodiments, as described hereinbefore, the charger 304 may be coupled to the rechargeable electrical energy storage 302 based on wired coupling (e.g., wires or conductors) or wireless coupling (e.g., wireless power transfer based on magnetic induction). In various embodiments, the charger controller 200 may be communicatively coupled to the charger 304 based on wired communication and/or wireless communication. Wired communication technologies and wireless communication technologies are well known in the art, and thus need not be described herein for clarity and conciseness. It will be appreciated by a person skilled in the art that the present invention is not limited to any particular type of wired or wireless communication technology.

In various embodiments, there is provided a computer program product, embodied in one or more computer-readable storage mediums (non-transitory computer-readable storage medium), comprising instructions (e.g., the charging parameter receiving module 210 and/or the controller module 212) executable by one or more computer processors to perform a method 100 of charging a rechargeable battery as described hereinbefore with reference to FIG. 1. Accordingly, various computer programs or modules described herein may be stored in a computer program product receivable by a system (e.g., which may also be embodied as a device or an apparatus) therein, such as the charger controller 200 shown in FIG. 2, for execution by at least one processor 204 of the charger controller 200 to perform the required or desired functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

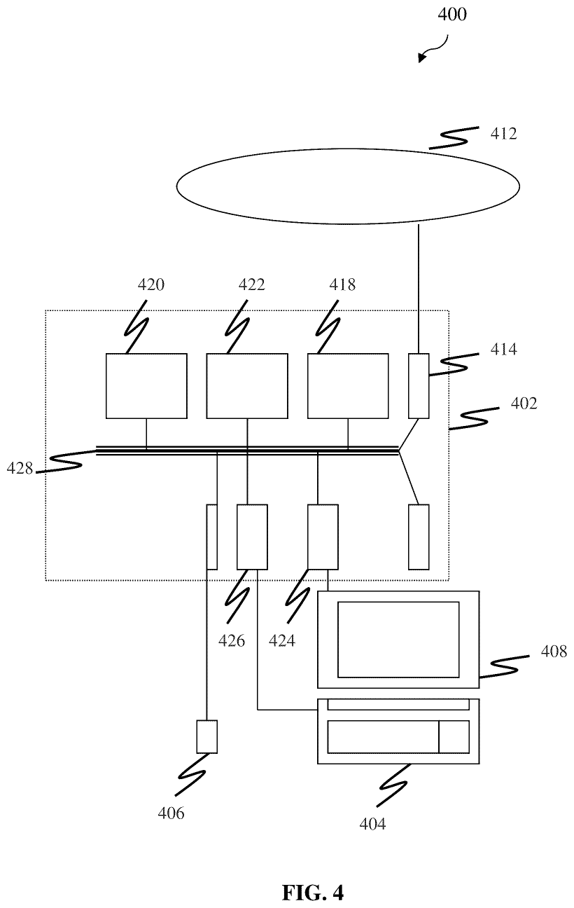

In various embodiments, the charger controller 200 may be realized by any computer system or device (e.g., a portable or desktop computer system or device, or an internal or built-in computer system or device installed in the charging system 300). As an example only and without limitation, the charger controller 200 may be realized or implemented as a computer system 400 as schematically shown in FIG. 4. The method or functional module may be implemented as software, such as a computer program being executed within the computer system 400, and instructing the computer system 400 (in particular, one or more processors therein) to conduct the methods/functions of various embodiments described herein. The computer system 400 may comprise a computer module 402, input modules (such as a keyboard 404, a mouse 406 and/or a touchscreen) and a plurality of output devices (such as a display 408). The computer module 402 may be connected to a computer network 412 via a suitable transceiver device 414, to enable access to, for example, the Internet or other network systems such as Local Area Network (LAN) or Wide Area Network (WAN). The computer module 402 in the example may include a processor 418 for executing various instructions, a Random Access Memory (RAM) 420 and a Read Only Memory (ROM) 422. The computer module 402 may also include a number of Input/Output (I/O) interfaces, for example, I/O interface 424 to the display 408, and I/O interface 426 to the keyboard 404. The components of the computer module 402 typically communicate via an interconnected bus 428 and in a manner known to the person skilled in the relevant art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art. In particular, for better understanding of the present invention and without limitation or loss of generality, various example embodiments of the present invention will now be described with respect to the rechargeable electrical energy storage being a rechargeable battery. However, as described hereinbefore, it will be appreciated by a person skilled in the art that the rechargeable electrical energy storage may refer to any electrical energy storage that is configured to supply electrical energy that is rechargeable, as suitable or as appropriate.

Various example embodiments of the present invention provide a battery charging technology (which may be referred to herein as the present battery charging technology) that enables and/or enhances flexible implementation of charging strategies and charging configuration to support various (different) sizes and types of battery based on a software defined charging profile (e.g., corresponding to the charging profile data as described hereinbefore according to various embodiments). According to the present battery charging technology, the method of charging a rechargeable battery according to various example embodiments can advantageously avoid limitations of specific battery types and sizes associated with conventional chargers (e.g., as explained in the background of the present invention), and for example, advantageously enables a universal battery charger (e.g., capable of supporting (e.g., configurable to support) a variety of different sizes and types of batteries). Due to the flexibility in implementing charging strategies as desired or as appropriate, the method of charging a rechargeable battery according to various example embodiments also advantageously offers future-proof solution that is able to accommodate new types of charging strategies and/or new types of batteries developed in the future.

According to various example embodiments, a programmable battery charging system may be provided and configured to perform the method of charging a rechargeable battery. For example, the programmable battery charging system may comprise a digital controller or a processor, such as a microcontroller, a programmable logic controller (PLC), field programmable gate array (FPGA), a digital signal processing (DSP) or the like, which may be configured to perform the method of charging a rechargeable battery based on executable instructions (e.g., an executable program). According to various example embodiments, the method of charging may be applied to any type of chargers as appropriate, such as wired or wireless chargers, for charging rechargeable batteries (or rechargeable supercapacitors or rechargeable electrochemical energy storages). Accordingly, due to the programmable nature, the method of charging a rechargeable battery according to various example embodiments is independent of hardware topology, and thus it is not limited to any specific converter topology, such as, buck, boost, buck-boost, flyback, half-bridge or full-bridge rectifier, or combinations thereof.

In general, batteries store electrochemical energy and convert the electrochemical energy to electrical energy when being used, and may be categorized as either rechargeable or non-rechargeable batteries. Due to their longer life cycle, rechargeable batteries (such as but not limited to, lithium-ion batteries, lead-acid batteries, and nickel-cadmium batteries) gained more popularity for applications, such as but not limited to, electric vehicles, portable electronics, mobile phones, and robots. Accordingly, the growing demand for battery-based applications drives the need for optimal charging strategies to avoid various battery related problems, such as accelerated battery degradation, overcharging, temperature rise, and over-voltage. For simplicity, unless stated or the context requires otherwise, the term “battery” or the like used herein refers to that having rechargeable capability (i.e., a rechargeable battery).

There exist a number of common conventional charging strategies (or charging techniques) for charging batteries, which will now be briefly described below.

### Constant Current (CC)

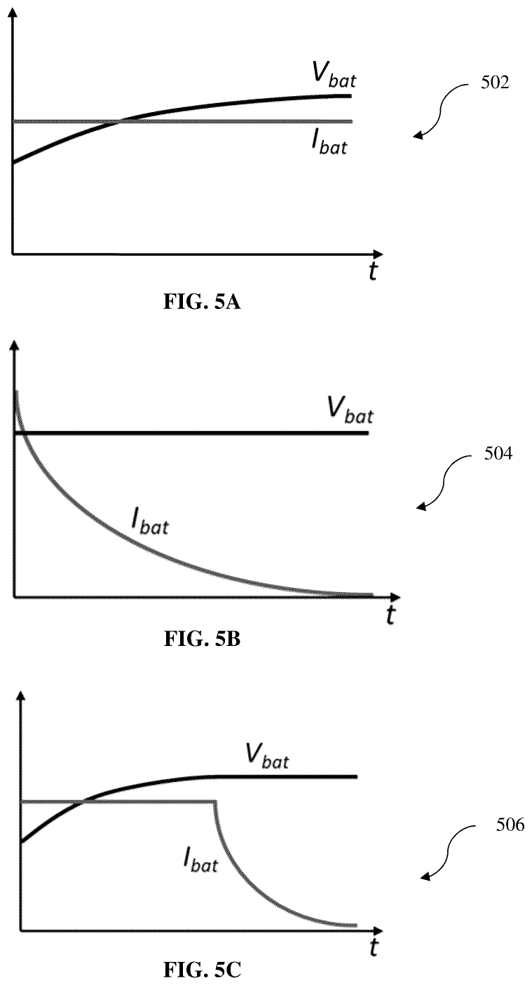

One of the most common conventional charging strategies is known as the constant current (CC) charging strategy. In this conventional charging strategy, a constant current is supplied to the battery depending on the charge and discharge rate (C-rate), and an example charging profile 502 of the constant current charging strategy is as shown in FIG. 5A. The charging process may be stopped when the battery voltage (V_{bat}) reaches a certain level of voltage.

### Constant Voltage (CV)

Another common conventional charging strategy is known as the constant voltage (CV) charging strategy, which maintains the battery voltage (V_{bat}) as shown in FIG. 5B instead of maintaining the charging current as shown FIG. 5A. In particular, FIG. 5B depicts an example charging profile 504 of the constant voltage charging strategy. For example, the initial charging current may be relatively high at the beginning due to a higher voltage difference between the battery voltage and the charging voltage. The charging current may then reduce overtime until it reaches a minimum limit of charging current (e.g., a predefined cut-off current value) and the charging of the battery may then be stopped (cut-off).

### Constant Current-Constant Voltage (CCCV)

In another conventional charging strategy, both of the constant current and constant voltage strategies may be combined as shown in FIG. 5C, and may be referred to as the constant current constant-voltage (CCCV) charging strategy. In particular, FIG. 5C depicts an example charging profile 506 of the CCCV charging strategy. For example, the charging process may begin with a constant current charging stage whereby a constant current may be supplied to the battery at the beginning of the charging process until the battery voltage (V_{bat}) reaches a maximum limit. The charging process may then proceed to the constant voltage charging stage whereby the battery voltage (V bar) is maintained and the charging current gradually decrease.

### Multi-Stage CCCV

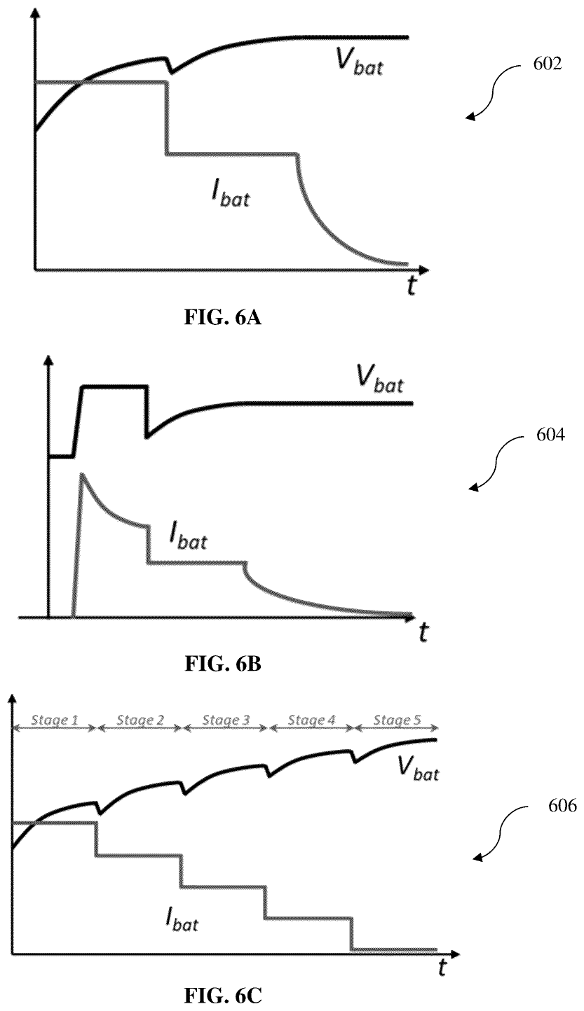

Combinations of multiple CC and CV stages have also been disclosed, which may be referred to as a multi-stage CCCV charging strategy (that is, multiple CC and CV stages in one charging process). FIGS. 6A to 6C depict example charging profiles of the conventional multi-stage CCCV charging strategy. As an example, FIG. 6A depicts an example multi-stage fast charging profile 602 having three different charging stages. This example multi-stage fast charging profile 602 has been disclosed to result in less temperature rise and an extended battery cycle life. FIG. 6B depicts another example charging profile 604 of the multi-stage CCCV charging strategy, which supplies maximum voltage (Vmax) during a very short time period, then subsequently followed by the conventional CCCV charging process (e.g., as described above with reference to FIG. 5C). This example charging profile 604 may be suitable for fully discharging a battery while minimizing inducing degradation effects. FIG. 6C depicts yet another example charging profile 606 of the multi-stage CCCV charging strategy, which may be referred to as a five-step constant current charging strategy. This example charging profile 606 has been disclosed to provide 57% more cycles and reduce 11% charging time.

### IUIa and IUIUa

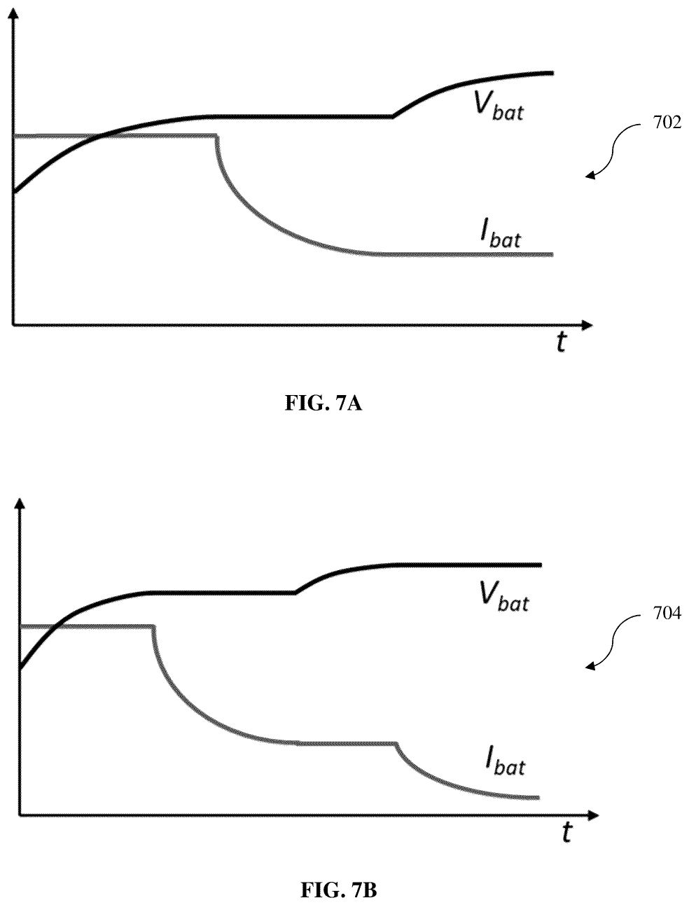

IUIa and IUIUa refer to charging characteristics described in DIN 41772 (“DIN 41772: Static Power Convertors; Semiconductor Rectifier Equipment, Shapes and Letter Symbol of Characteristic Curve,” German Institute for Standardisation). The “I” notation refers to constant current (CC) characteristics, while the “U” notation refers to constant voltage (CV) characteristics. Notations “a” refer to charging regimes with automatic shut off. Both the IUIa and IUIUa charging strategies may be categorised as a multi-stage CCCV charging strategy. FIGS. 7A and 7B depict example charging profiles 702, 704 of the IUIa and IUIUa charging strategies, respectively. In the IUIa charging strategy, the charging process may start with constant current (CC1), followed by constant voltage (CV1) and constant current (CC2) at lower current, and finally end with an automatic shut off. In the IUIUIa charging strategy, the charging process may be similar to or the same as the IUIa charging strategy, except it has an additional constant voltage (CV2) stage before the automatic shut off.

### Wa and W0Wa Curve

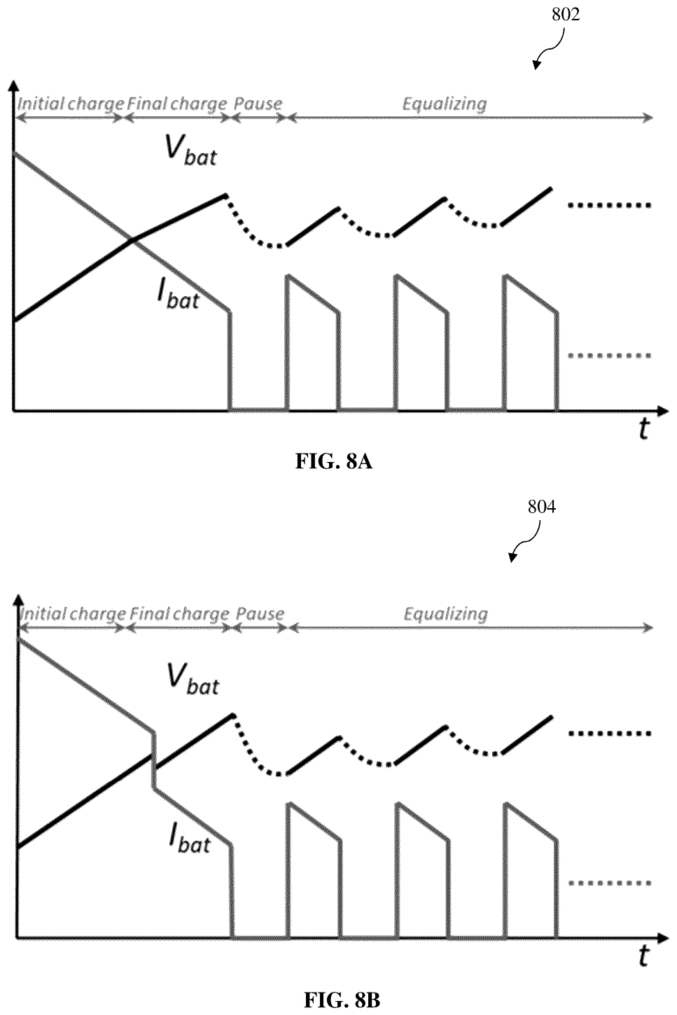

Wa and W0Wa refer to charging characteristics described in the above-mentioned DIN 41772. The “W” notation refers to slope charger characteristics with decreasing current (e.g., may be referred to as a taper charger characteristic) or increasing current (e.g., may be referred to as a boost charger characteristic). Notations “0” (zero) and “a” refer to charging regimes with automatic switch over and automatic shut off, respectively. FIG. 8A depicts an example charging profile 802 of the Wa charging strategy. As shown, the Wa curve may start from a high current that gradually decreases (tapers). At 50% of the cell voltage, the increment of battery voltage (V_{bat}) may slow down while the battery current (I_{bat}) keeps decreasing until 25% of the charging current. FIG. 8B depicts an example charging profile 804 of the W0Wa charging strategy. As shown, the W0Wa charging strategy (or the W0Wa curve) may be the same as or similar to the Wa charging strategy, except that at 50% of cell voltage, the charging current is levelled down significantly with different slope of decreasing current. Both the Wa and W0Wa curves may be followed by an equalizing stage whereby the charging current is repeatedly applied with a small period of pause in charging.

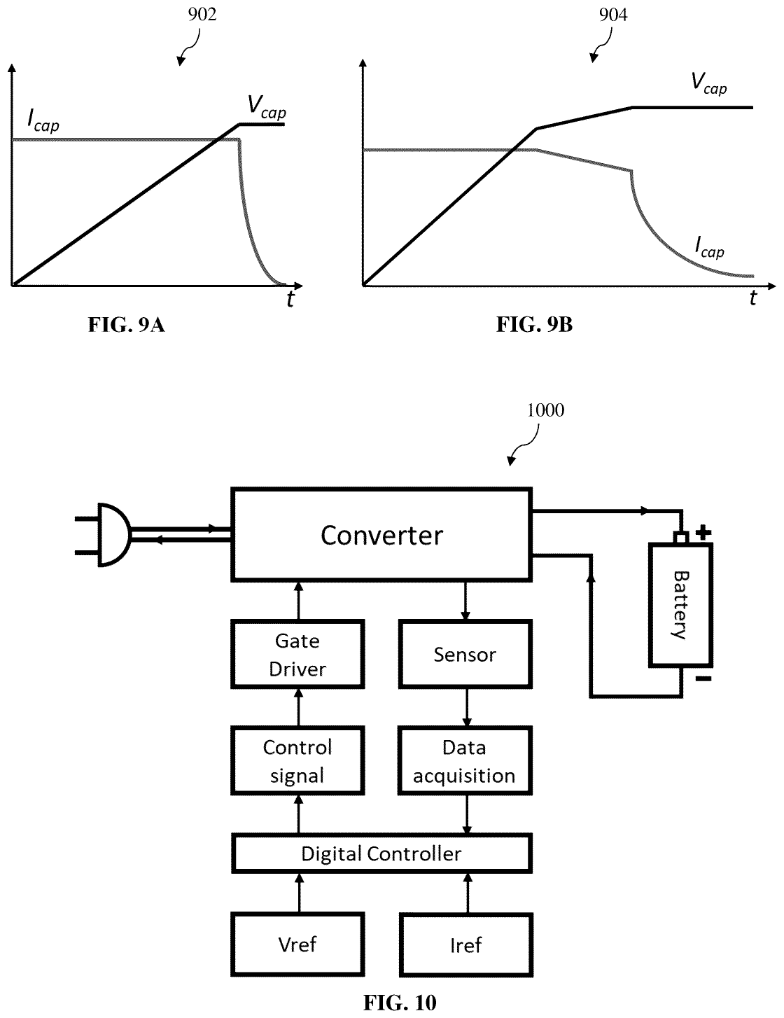

Supercapacitor (which may also be referred to as an ultracapacitor) has a unique property compared to battery whereby it can withstand a much larger amount of current compared to battery with the same energy level. For example, an undercharged supercapacitor can draw maximum current from a power source due to its low equivalent series resistance (ESR). FIGS. 9A and 9B depict two example charging profiles 902, 904 for a supercapacitor. For example, as shown in FIG. 9A, a charging strategy of supercapacitor may start with constant current whereas the voltage may linearly increase until its maximum voltage (V_{cap}). Then, the charging process may continue to maintain the voltage level (V_{cap}) while the charging current drops. As another example, as shown in FIG. 9B, a charging strategy of supercapacitor may start with constant current whereas the voltage may linearly increase until its first reference voltage. Then, the charging process may continue to gradually decreases (tapers) the capacitor current (I_{cap}) as the voltage (V_{cap}) increases until its maximum voltage. Subsequently, the charging process may continue to maintain the voltage level (V_{cap}) in constant voltage stage.

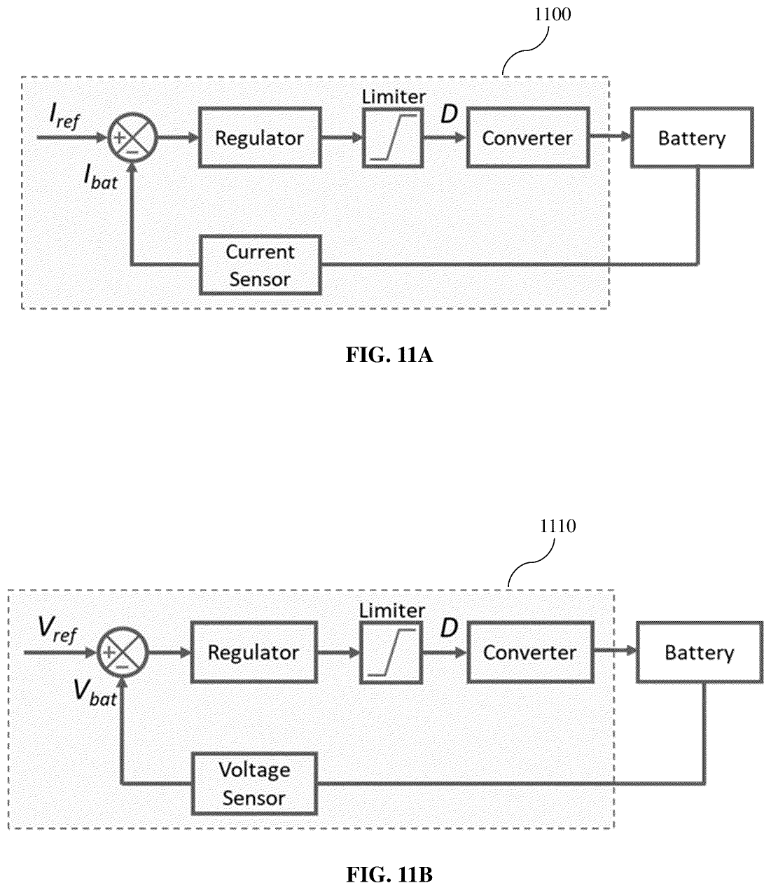

FIG. 10 depicts a schematic block diagram of a conventional digital based charger system 1000. The digital based charger system 1000 comprises a converter configured to transfer power to the battery; a gate driver configured to control the switching of the converter based on the control signal provided by the digital controller; and sensors configured to collect data such as, but not limited to, battery voltage and charging current, that may be digitalized into sensor data by the data acquisition module. The digital controller may process the feedback data from the data acquisition module and compares them to the voltage reference and current reference to produce control signals for controlling the charging process. Therefore, the digital controller is able to regulate the charging voltage and current to follow the given voltage reference and current reference. Accordingly, the digital controller is typically implemented in the form of a feedback controller, which manipulates the input to the converter based on the output of the converter routed to the feedback controller, thereby creating a feedback loop. For example, the regulated variables in the digital based charger system 1000 may be charging current, battery voltage, or a combination thereof.

For example, charging profiles, such as those described in FIGS. 5 to 9, may be implemented by using a feedback controller. FIG. 11A depicts a schematic block diagram (constant current control block diagram) of an example charger 1100 implemented based on a feedback controller configured for the constant current (CC) charging profile. As shown, the example charger 1100 may be connected to a battery for charging the battery. For example, the current reference (I_{ref}) may be configured based on the battery's charge rate, and feedback of the battery charging current (I_{bat}) may be obtained from a current sensor. Accordingly, the difference or error between the current reference and the current feedback may thus drive the regulator output. In this regard, the output of the regulator may be a control signal in the form of a duty cycle (D). A limiter may be provided for restricting the maximum value of the duty cycle (D). The converter may be configured to provide a voltage output to battery in proportion to the duty cycle value. For example, when the battery charging current is lower than the current reference, the difference between I_{ref} and I_{bat} drives the regulator to increase the duty cycle (D). As a result, the voltage output by the converter increases, as well as the battery current. On the other hand, when the battery current is higher than the current reference, the regulator is driven to decrease the voltage output of the converter. As a result, the battery current (I_{bat}) can be maintained very close to the current reference (I_{ref}).

FIG. 11B depicts a schematic block diagram (constant voltage control block diagram) of an example charger 1110 implemented based on a feedback controller configured for the constant voltage (CV) charging profile, which may be implemented in a similar manner as the example charger 1100 configured for the constant current charging profile. In particular, instead of using the battery current as a feedback, the example charger 1100 uses the battery voltage (V_{bat}) as a feedback. Therefore, the battery voltage (V_{bat}) can be maintained very close to the voltage reference (V_{ref}). Depending on the battery, voltage reference may typically be configured to the maximum battery or cell's voltage.

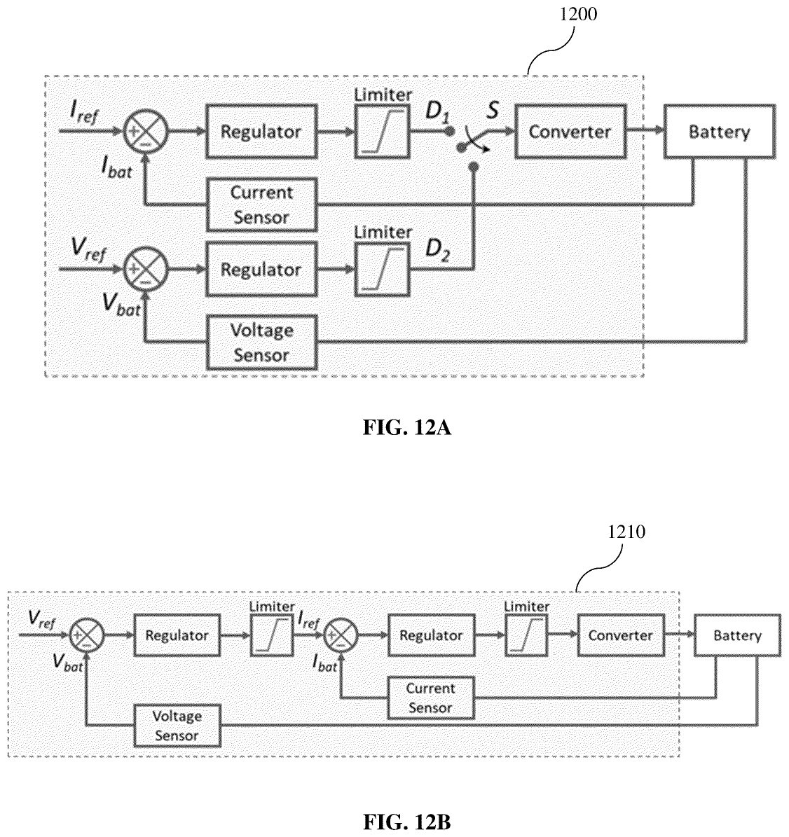

FIG. 12A depicts a schematic block diagram (switched CCCV control block diagram) of an example charger 1200 implemented based on a feedback controller configured for the constant current constant voltage (CCCV) charging profile, which may be referred to as a switched CCCV charging configuration. Voltage reference and current reference can be configured based on battery characteristics. Initially, the constant current (CC) charging may be supplied to the battery by connecting the switch (S) to the current regulator. When the battery voltage (V_{bat}) reaches a certain level of voltage, the switch (S) is connected to the voltage regulator for the constant voltage (CV) charging.

However, the sudden switching from CC to CV may create transient in the battery voltage. FIG. 12B depicts a schematic block diagram (series CCCV control block diagram) of another example charger 1210 implemented based on a feedback controller configured for another form of the CCCV charging configuration, which may be referred to as a series CCCV charging strategy, whereby the voltage and current regulators are cascaded in series. In the example charger 1210, the battery voltage (V_{bat}) and current reference (I_{ref}) are the same as the example charger 1200 shown in FIG. 12A, except that the output of voltage regulator is passed on as the current reference. For example, when the battery voltage is far below the voltage reference (V_{ref}), the output of voltage regulator is limited to current reference (I_{ref}). As a result, a constant current is supplied to the battery. Overtime, the battery voltage is gradually increased close to the voltage reference. At this time, the charging current is reduced and the battery voltage is maintained at the voltage reference. By using this implementation, the sudden switch from CC to CV can be avoided and the transient in battery voltage can be eliminated.

The implementation of the conventional digital charger system 1000 as shown in FIG. 10 has the capability to regulate the reference values, such as current reference value and voltage reference value, to follow appropriate charging strategies. However, firstly, various example embodiments note that the conventional digital charger system 1000 can only charge a specific type (or model) of battery because the voltage reference and the current reference are each fixed to one value. Secondly, the implementation is limited to certain predetermined charging strategies that generally cannot be modified once implemented, such as constant current (CC), constant voltage (CV), and constant current-constant voltage (CCCV). Therefore, the conventional digital charger system 1000 does not provide flexibility in implementing charging strategies for supporting various (different) battery sizes and types.

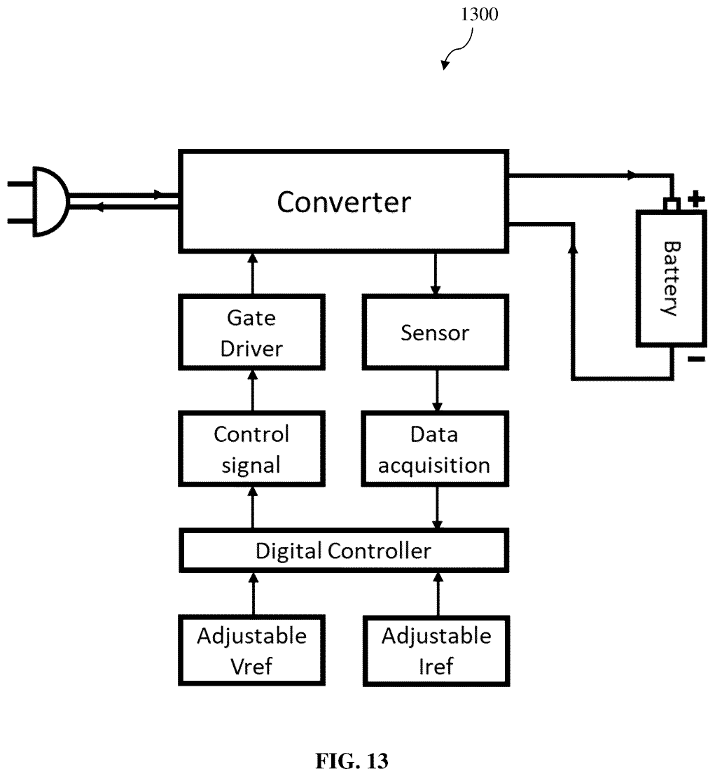

The above-mentioned first limitation may be partially addressed by using adjustable reference values whereby the user can change the reference voltage and current settings by using an external physical interface, such as a switch or a potentiometer. In particular, the fixed voltage and current references as shown in FIG. 10 may be replaced by adjustable voltage and current references as shown in FIG. 13. In particular, FIG. 13 depicts a schematic block diagram of a conventional adjustable battery charger system 1300. As a result, the charger system 1300 may be used for different sizes of batteries with different voltage ratings and current ratings. While this implementation provides a certain degree of flexibility to charge different sizes of batteries, it still has the limitation of specific battery types. Furthermore, since the charger system 1300 is still limited to certain simple predetermined charging strategies that generally cannot be modified once implemented, such as constant current (CC), constant voltage (CV), and constant current-constant voltage (CCCV), the charger system 1300 also suffers from corresponding limitations that are found in the conventional charger system 1000 shown in FIG. 10. For example, more complex and recurring charging strategies (e.g., those as shown in FIG. 6, FIG. 7 and FIG. 8) cannot be efficiently and/or effectively implemented using the conventional adjustable battery charger system 1300.

In contrast, various example embodiments of the present invention advantageously provide a battery charger technology that supports flexible configuration of charging profiles (i.e., configurable charging profiles) for different sizes and types of rechargeable electrical energy storage (e.g., electrochemical storages, such as batteries), and more particularly, a programmable (configurable) charging profile configured to support a particular electrical energy storage size and type (e.g., suitable or optimized for the particular electrical energy storage size and type) as desired or as appropriate. Therefore, according to the present battery charging technology, the method of charging a rechargeable battery according to various example embodiments can advantageously avoid limitations of specific battery types and sizes associated with conventional chargers (e.g., as explained in the background of the present invention), and thus, for example, advantageously enables a universal battery charger. Accordingly, due to the flexibility in implementing charging strategies as desired or as appropriate, the method of charging a rechargeable battery according to various example embodiments also advantageously offers future-proof solution that is able to accommodate new types of charging strategies and/or new types of batteries developed in the future. For better understanding, a charging system 1400 will now be described according to various example embodiments of the present invention.

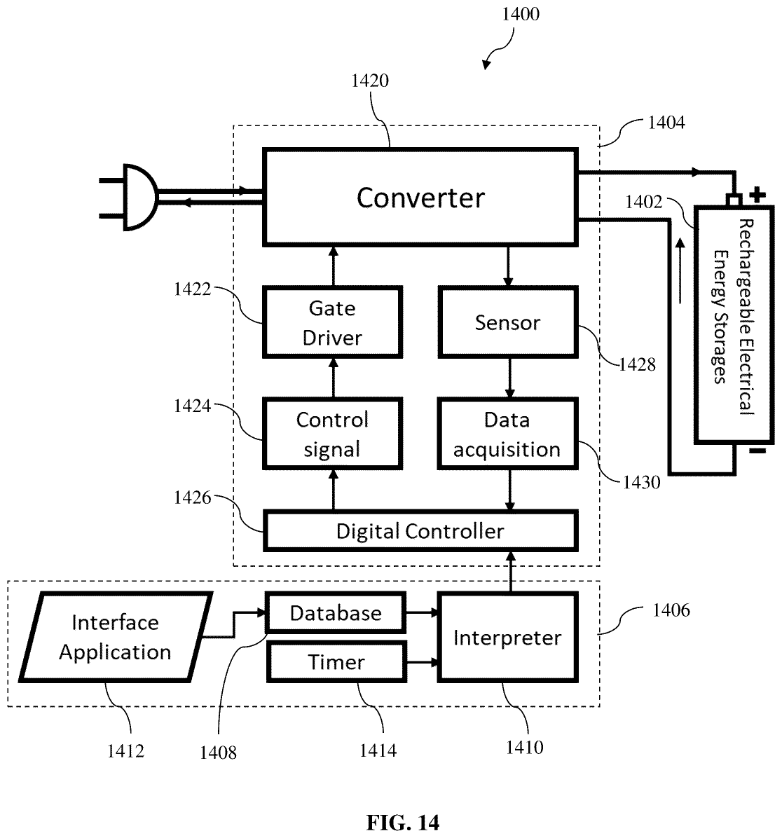

FIG. 14 depicts a schematic block diagram of a charging system 1400 for charging a rechargeable battery according to various example embodiments of the present invention. The charging system 1400 comprises a charger 1404 coupled or couplable to the rechargeable battery 1402; a charger controller 1406 comprising a data storage having stored therein a database 1408 (e.g., corresponding to the memory 202 as described hereinbefore according to various embodiments), an interpreter 1410 (e.g., corresponding to the charging parameter receiving module 210 and the controller module 212 as described hereinbefore according to various embodiments), an application interface 1412 (e.g., corresponding to the data input user interface as described hereinbefore according to various embodiments), and a timer 1414. In various example embodiments, the charger 1404 may comprise the same or similar corresponding components as the conventional charger system 1000 shown in FIG. 10 and configured to operate or function in the same or similar manner. For example, the charger 1404 may similarly comprise a converter 1420 configured to transfer power to the battery 1402; a gate driver 1422 configured to control the switching of the converter 1420 based on the control signal provided by the digital controller 1426; and sensors 1428 configured to collect data such as, but not limited to battery voltage and charging current, that may be digitalized into sensor data by the data acquisition module 1430. The digital controller 1426 may process the feedback data from the data acquisition module and compares them to the voltage reference and current reference received from the charger controller 1406 (or more specifically, from the interpreter 1410) to produce control signals for controlling the charging process. Therefore, the digital controller 1426 is able to regulate the charging voltage and current to follow the voltage reference and current reference received. Accordingly, the digital controller 1426 may be implemented in the form of a feedback controller, which manipulates the input to the converter 1420 based on the output of the interpreter 1410 and the output of the converter 1420 routed to the feedback controller, thereby forming a feedback loop.

In various example embodiments, the digital controller 1426 may be configured to receive voltage and current references (e.g., corresponding to the output reference voltage value and the output reference current value generated by the charger controller 200 as described hereinbefore according to various embodiments) output from the interpreter 1410. These voltage and current references may be determined by the interpreter 1426 based on charging parameters received from the database 1408 and the timer 1414. The timer 1414 may be configured to provide continuous time unit counter to the interpreter 1410 such that it can run scheduling and timing functions to produce the voltage and current references. The database 1408 may include charging parameters (which may also be referred to herein as charging configuration information) configured for a specific battery (e.g., a specific battery type and size). In various embodiments, the database 1408 may be stored in non-volatile memory to retain the charging parameters even after the charging system 1400 or the charger controller 1406 is cut-off from its power supply. In various example embodiments, the database 1408 (e.g., the charging parameters therein) is configurable and may be configured or modified to cater a particular charging profile for a particular type and/or size of battery. In various example embodiments, the configuration or modification of the database 1408 may be performed through the application interface 1412 which a user may interact with (e.g., based on one or more input interfaces, such as but not limited to, a keyboard, a keypad, a touchscreen, a mouse and so on). In various example embodiments, the application interface 1412 may be embedded or installed in the charging system 1400 (or the charger controller 1404) or may be provided separately (e.g., as a separate unit) from the charging system 1400. For example, in the case of the application interface 1412 being provided separately from the charging system 1400, the application interface 1412 may be communicatively coupled to the charging system 1400 (or more specifically, the charger controller 1410 via wired or wireless communication protocols known in the art, such as but not limited to, Controller Area Network (CAN), Ethernet, Inter-Integrated Circuit (I2C) protocol, Serial Peripheral Interface (SPI), Recommended Standard 232 (RS232), Universal Serial Bus (USB), and so on.

Accordingly, various example embodiments provide a battery charger technology that supports flexible configuration of charging profiles (i.e., configurable charging profiles) for different sizes and types of rechargeable batteries, and more particularly, a programmable (configurable) charging profile configured to support a particular electrical energy storage size and type (e.g., suitable or optimized for the particular electrical energy storage size and type) as desired or as appropriate. Therefore, according to the present battery charging technology, the method of charging a rechargeable battery according to various example embodiments can advantageously avoid limitations of specific battery types and sizes associated with conventional chargers, such as those described with reference to FIG. 10. For example, the database 1408 can be configured or modified to have a different charging profile to avoid limitations of specific battery type, such as those described with reference to FIG. 13. Furthermore, in various example embodiments, the method of charging a rechargeable battery may also provide recurring or loop capabilities such that one or more charging profiles may be executed multiple times in a charging loop.

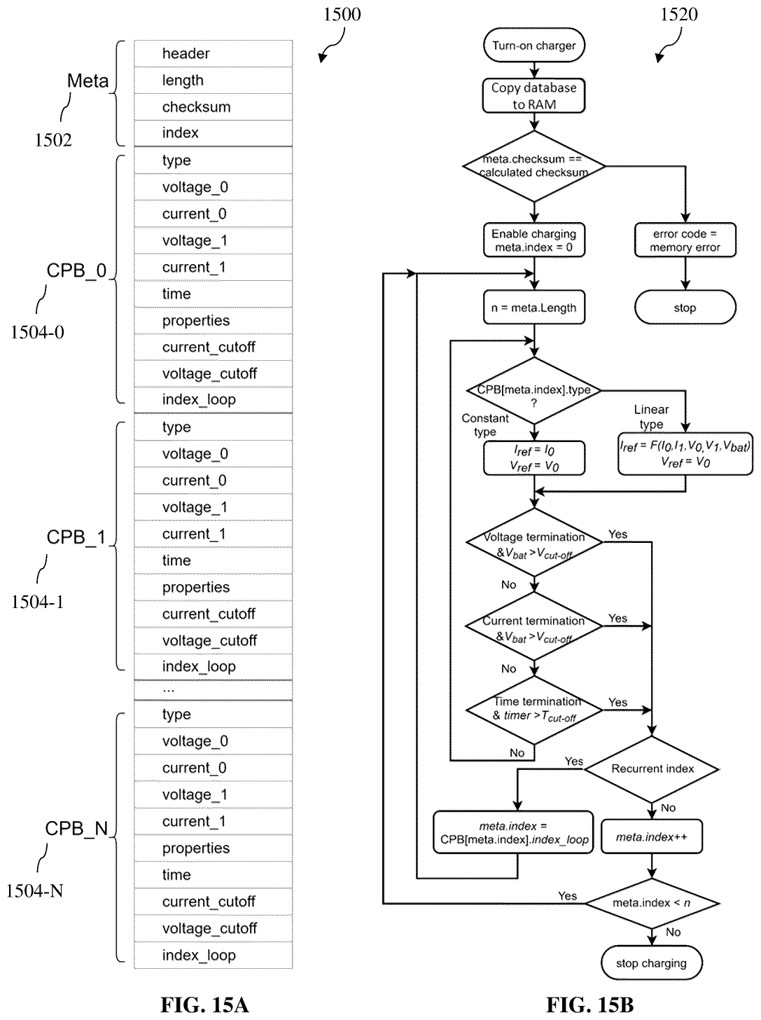

In various example embodiments, the database 1408 (e.g., corresponding to the charging profile data as described hereinbefore according to various embodiments) may be configured to store a set of charging parameters (which may also be referred to herein as charging configuration information) configured for one charging profile. As described hereinbefore, the database 1408 may be stored in a non-volatile memory, such as a flash or Read-Only Memory (ROM), such that the interpreter 1410 may be able to read, interpret, and execute based on the charging parameters stored in the database 1408 during the charging process. For clarity and simplicity, only the one database 1408 may be described herein. However, it will be appreciated by a person skilled in the art that the present invention is not limited to performing charging based on one database, and multiple databases (e.g., for multiple charging profiles, respectively) may be provided as desired or as appropriate, without deviating from the scope of the present invention. In various example embodiments, the database 1408 may be copied to a volatile memory, such as Random Access Memory (RAM), by the interpreter 1410 when the charging process starts. In various example embodiments, as shown in FIG. 15A, the database 1408 may have a database structure (or data structure) 1500 comprising two sections or portions, namely, a metadata or meta information portion and a charging profile portion. In particular, FIG. 15A depicts a schematic drawing of an example database structure 1500 of the database 1408 according to various example embodiments of the present invention for a charging profile for charging a rechargeable battery. The meta information portion 1502 may include a plurality of predefined metadata fields for storing a plurality of metadata parameters. The charging profile portion may include a plurality of charging profile blocks (CPBs) 1504-0, 1504-1 and 1504-N for defining a plurality of charging stages, respectively, of the charging profile. As shown in FIG. 15A, each CPB may comprise a plurality of predefined charging parameter data fields for storing a plurality of charging parameters associated with the CPB for the corresponding charging stage.

By way of an example only and without limitations, example metadata fields (and thus the corresponding metadata parameters) will now be described below according to various example embodiments of the present invention. In general, the metadata fields may define attributes for the database structure, such as including:
a header field, which may be configured to store a header parameter for indicating that this is a database for a charging profile (i.e., a charging profile data), and may be the starting point or the header portion of the database 1408.
a length field, which may be configured to store a length parameter for indicating the number of CPBs in the database 1408.
a checksum field, which may be configured to store a checksum parameter for verifying the integrity of charging parameters (or data values) in all of the CPBs in the database 1408.
an index field, which may be configured to store an index parameter indicating the particular CPB in that the database 1408 that the interpreter 1410 is to begin or start with for the charging process. For example, the index field may have a default value of 0, which indicates that the CPB having an index of 0 (e.g., the first CPB) should be processed or executed first (i.e., the charging parameters thereof) in the database 1408.

In various example embodiments, one CPB may be configured to define a charging stage (e.g., a charging segment, such as a minimum charging segment) of the charging profile (e.g., which may also be referred to as a charging profile curve). In various example embodiments, the number of CPBs included in the database 1408 for a charging profile may be configured as desired or as appropriate, such as depending on the desired characteristics or configuration of the charging profile (e.g., depending on the specific charging strategy) for charging the rechargeable battery. For example, multiple CPBs may be provided in the database 1408 for corresponding multiple charging stages of the charging profile, such as denoted as CPB_0 (e.g., the first CPB) 1504-0, CPB_1 1504-1, and so on until CPB_N 1504-N (e.g., the last CPB), and may be indexed correspondingly.

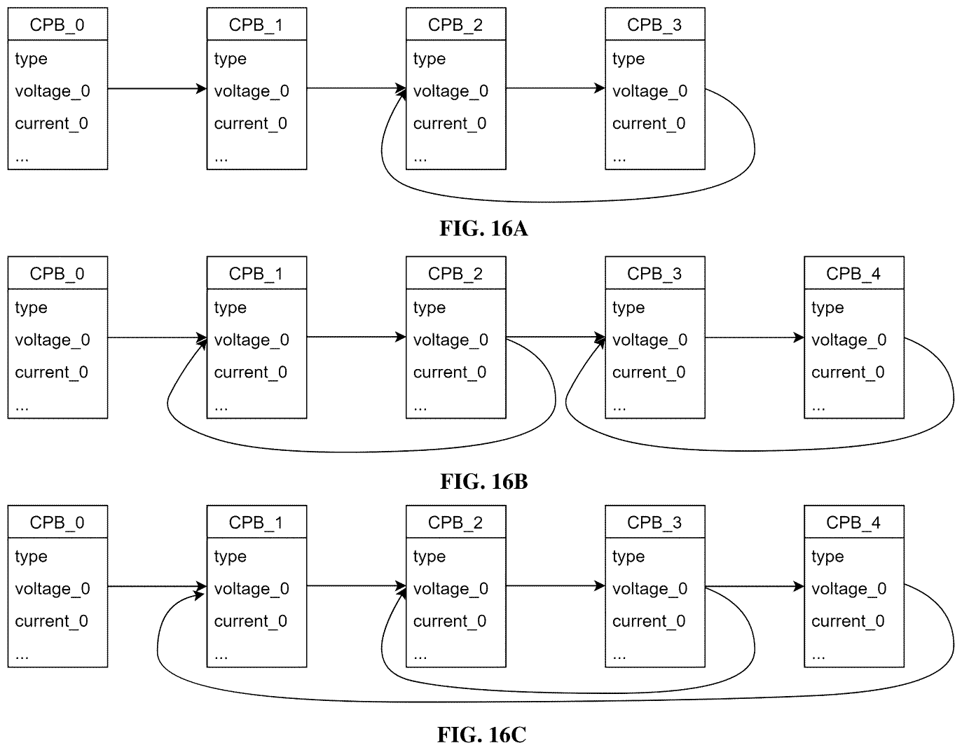

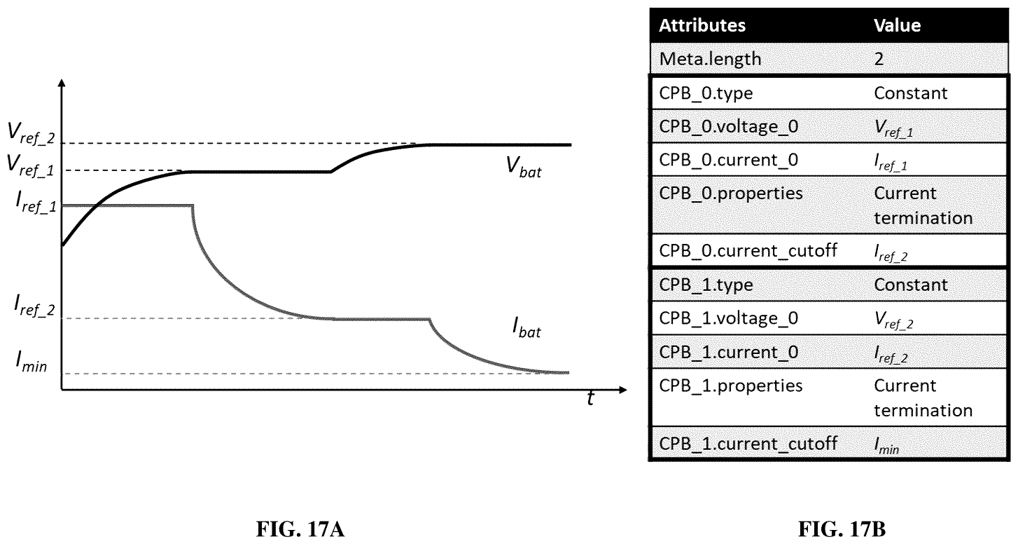

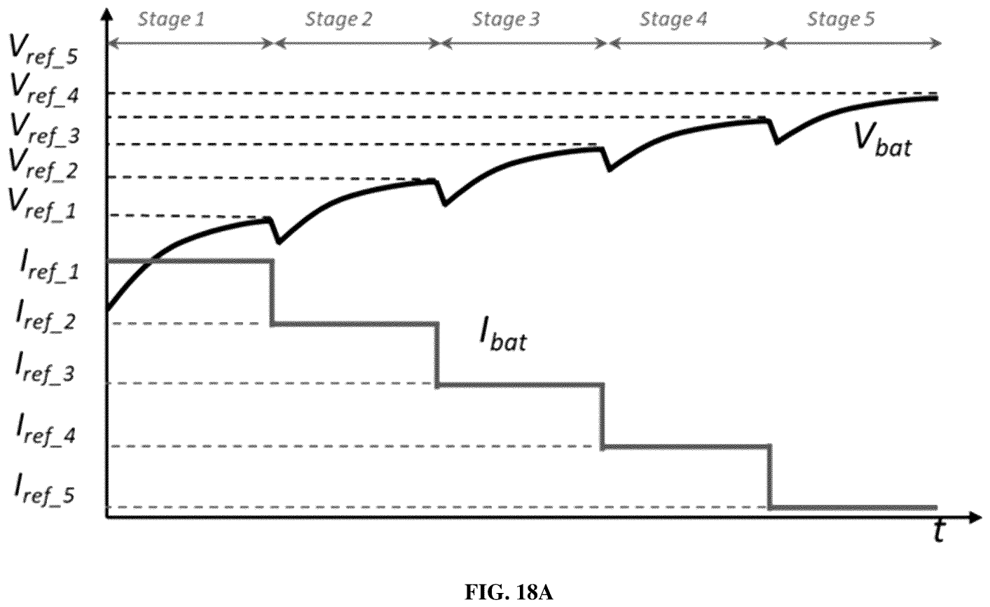

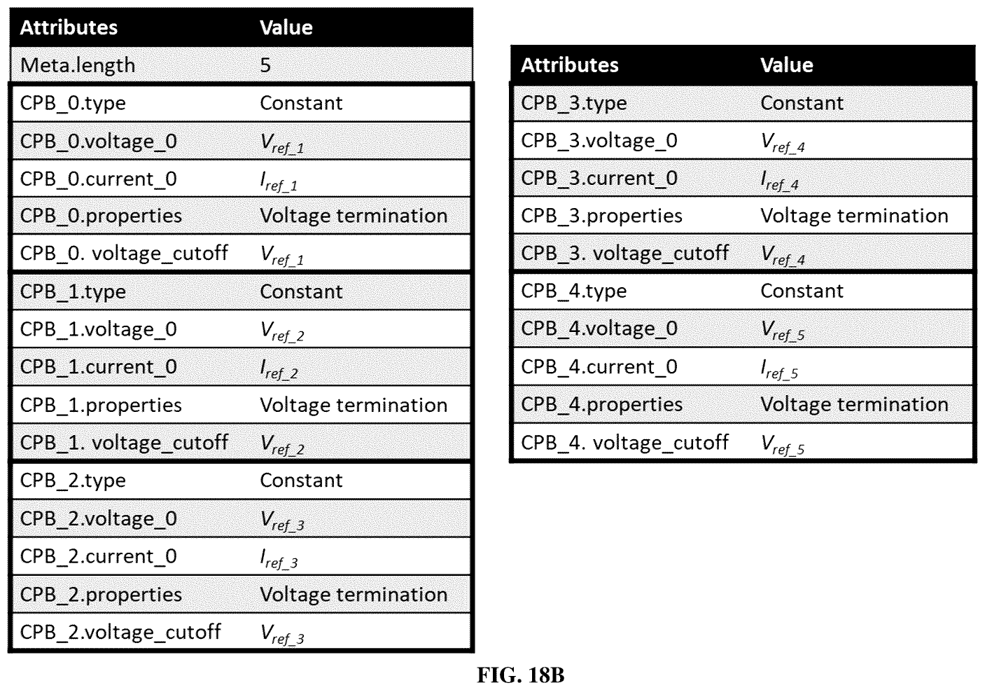

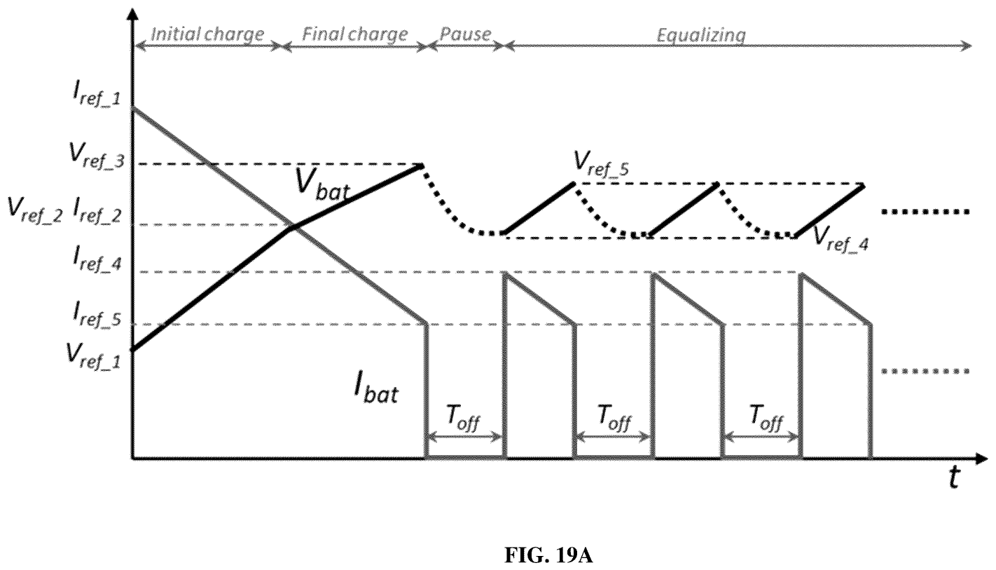

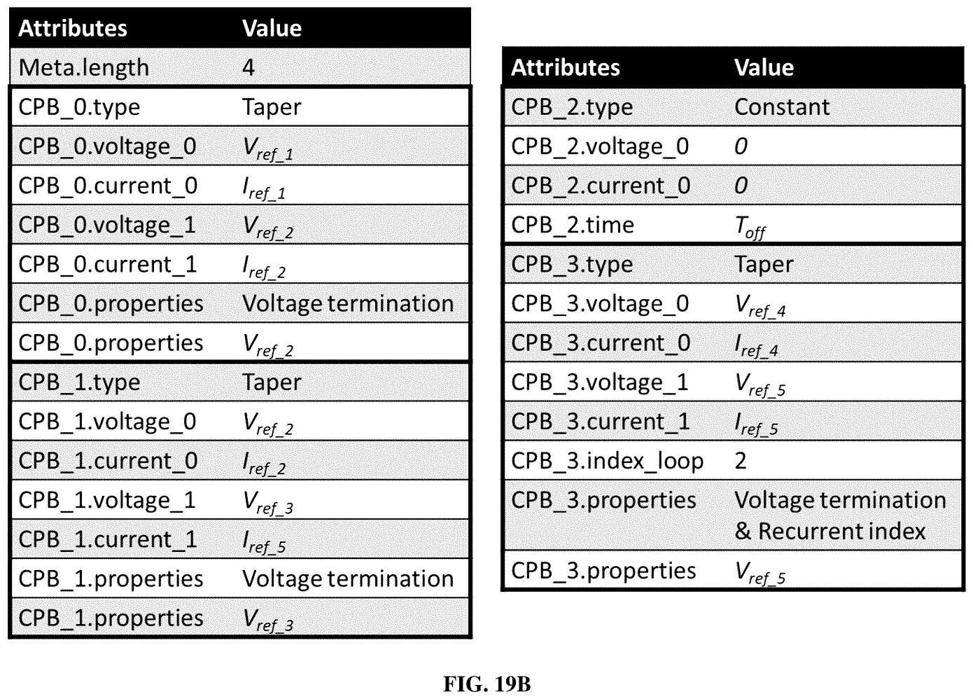

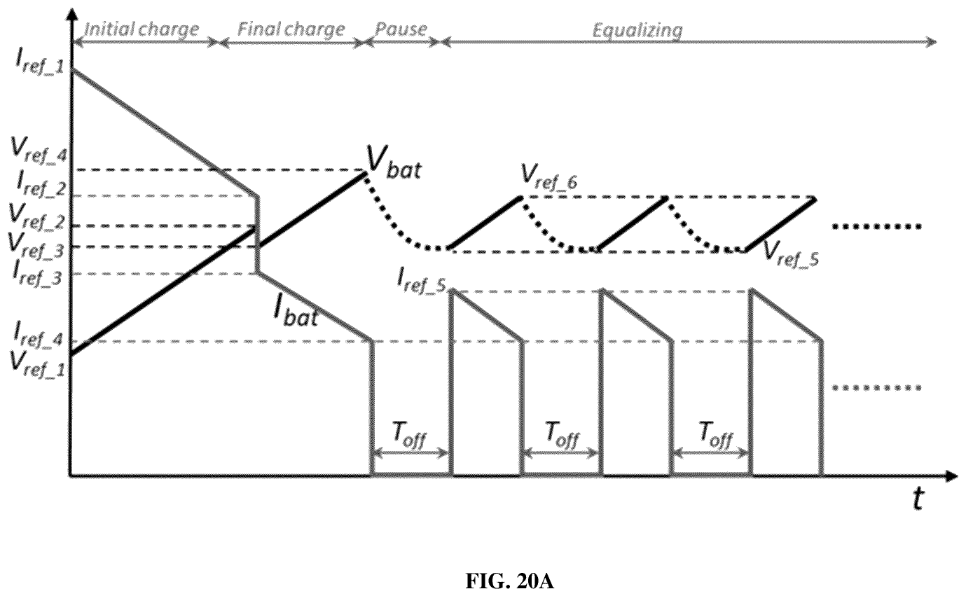

By way of an example only and without limitations, example charging parameter fields (and thus the corresponding charging parameters) will be described below according to various example embodiments of the present invention. In general, the charging parameter fields in a CPB may define attributes for defining the characteristics of the corresponding charging stage of the charging profile, such as including:
a type field (e.g., corresponding to the charging type parameter data field as described hereinbefore according to various embodiments), which may be configured to store a type parameter for indicating (or defining) the charging type (e.g., charging function, model or style) for the corresponding charging stage (e.g., which charging function should be used). For example, the charging function may be a constant type or a slope type (e.g., which may include a taper type and a boost type). For example, the constant type may refer to the constant current constant voltage (CCCV) charging profile (e.g., similar to FIG. 5C). The taper type may be utilized to implement taper charger characteristics with decreasing current such as explained hereinbefore with reference to the DIN 417772 (e.g., similar to the initial charge stage of the charging profile shown in FIG. 19A). The boost type may be utilized to implement boost charger characteristics with increasing charging current (e.g., opposite of the taper type).
voltage_0 and voltage_1 fields (e.g., corresponding to the first reference voltage parameter data field and the second reference voltage parameter data field, respectively, as described hereinbefore according to various embodiments), which may be configured to store first and second voltage parameters, respectively, for indicating (or defining) the start and stop voltage values of the corresponding charging stage.
current_0 and current_1 fields (e.g., corresponding to the first reference current parameter data field and the second reference current parameter data field, respectively, as described hereinbefore according to various embodiments), which may be configured to store first and second current parameters, respectively, for indicating (or defining) the start and stop current value of the corresponding charging stage.
a properties field, which may be configured to store one or more property parameters for indicating (or defining) one or more charging properties, features or modes of the corresponding charging stage, as appropriate, such as but not limited to, time termination, current termination, voltage termination, and recurrent index. The number of property parameters may be expanded to indicate or define additional features or modes as required or appropriate. By way of an example, as will be described later below with reference to FIGS. 17A and 17B, in the case of the properties field having stored therein a property parameter indicating current termination, the charging mode may be set to having a current cut-off value (e.g., current termination mode enabled) as defined by the current cut-off parameter from the current_cut-off field (which will be described below). As another example, as will also be described later below with reference to FIGS. 18A and 18B, in the case of the properties field having stored therein a property parameter indicating voltage termination, the charging mode may be set to having a voltage cut-off value (e.g., voltage termination mode enabled) as defined by the voltage cut-off parameter from the voltage_cut-off field (which will be described below).
a time cut-off field, which may be configured to store a time parameter for indicating (or defining) the longest time (or time period) that the corresponding charging stage can last if no other cut-off condition is met. For example, if the time parameter has a value of 0, this may indicate that the corresponding charging stage has no time limit and the cut-off may be performed based on other charging parameter(s), such as current cut-off parameter or voltage cut-off parameter.
a current_cut-off field (e.g., corresponding to the cut-off current parameter data field as described hereinbefore according to various embodiments), which may be configured to store a current cut-off parameter for indicating (or defining) the lowest value of charging current that can be reached in the corresponding charging stage before it is cut-off. For example, the corresponding charging stage may be considered to be complete or ended if the charging current is lower than the value indicated by the current cut-off parameter.
a voltage_cut-off field (e.g., corresponding to the cut-off voltage parameter data field as described hereinbefore according to various embodiments), which may be configured to store a voltage cut-off parameter for indicating (or defining) the highest value of battery voltage that can be reached in the corresponding charging stage before it is cut-off. For example, the corresponding charging stage may be considered to be complete or ended if the battery voltage is higher than the value indicated by the voltage cut-off parameter.
an index_loop field (e.g., corresponding to the index parameter field as described hereinbefore according to various embodiments), which may be configured to store an index loop parameter for indicating (or defining) the next CPB that is to be executed in the charging process for the next charging stage. Accordingly, the index loop parameter can be used to form a charging loop, thereby enabling the method to charging to support or implement more complex or recurring charging strategies, such as for the equalizing stage as shown in FIG. 8A and FIG. 8B. Furthermore, by utilizing this recurrent feature and the index loop parameter, the number of CPBs stored in the database 1408 can also be advantageously minimized, thereby resulting in less memory footprint. By way of examples only and without limitations, FIGS. 16A to 16C depict schematic flow diagrams of example charging processes performed, including recurring charging strategies, based on CPBs, according to various example embodiments of the present invention. For example, as shown in FIG. 16A, in CPB_3, the properties field may include a property parameter indicating that index loop has been enabled and the index_loop field may include an index loop parameter having a value set to 2. Accordingly, after the charging stage of CPB_3 has ended, the charging process may then loop back to CPB_2 (i.e., the CPB having an associated index corresponding to the above-mentioned value of the index loop parameter stored at CPB_3). As a result, a charging loop of CPB_0→CPB_1→CPB_2→CPB_3→CPB_2→CPB_3→CPB_2→CPB_3 and so on (e.g., until a charging termination condition is met at CPB_3 as defined by another property parameter indicating the termination mode (e.g., the above-mentioned voltage or current termination mode)) can be formed as shown in FIG. 16A. It will be appreciated by a person skilled in the art that the recurrent index feature disclosed herein is not limited to forming only one charging loop, but multiple charging loops may also be formed as desired or as appropriate to realize a desired charging profile by setting one or more index loop parameters in one or more other CBPs, such as shown in FIGS. 16B and 16C.

In various example embodiments, corresponding attributes may be called or retrieved based on a dot notation to notify the object that is associated with them, for example, meta.header or CPB_0.time.

In various example embodiments, the interpreter 1410 may be configured to process charging parameters stored in the database 1408, count the timing data from the timer 1414, and generate voltage and current references for output to the charger 1404 (or more specifically, to the digital controller 1426). By way of an example only and without limitations, FIG. 15B depicts a flowchart of a method 1520 of charging a rechargeable battery performed by the interpreter 1410 (which may be referred to as the interpreter runtime routine or the charging profile run-time routine). For example, the interpreter runtime may start when the charging system 1400 or the charger controller 1404 is turned on. The interpreter 1410 may then proceed to copy the corresponding database 1408 to a RAM and calculate the checksum. The interpreter 1410 may continue running if the checksum is matched (i.e., correct), otherwise, an error may be raised and the charging process may thus stop.

In various example embodiments, the interpreter runtime may keep running and tracking the time provided by the timer 1414 while the charging process is ongoing. The interpreter runtime may go through the CPBs in the database 1408 one by one sequentially (i.e., one after another). The voltage and current references may be computed based on the current CPB.type and the time recorded. For example, in the charging process, the next CPB may be executed only after the current CPB is cut off or timeout. The interpreter runtime may end the charging process if a termination condition at the last CPB is satisfied (e.g., is cut off or timeout). In various example embodiments, as described hereinbefore, the next CPB may also be assigned by the current CPB by configuring the index loop parameter for indicating (or defining) the next CPB that is to be executed in the charging process for the next charging stage. For example, if the index of the index loop parameter stored at a current CPB is less than the index of the current CPB, then a charging loop may be formed, and the charging process may continue accordingly. Otherwise, in various example embodiments, the charging process executed by the interpreter 1410 may simply proceed to the next CPB according to the indexing sequence (e.g., the next CPB may have an index value incremented by one compared to the index of the current CPB).

In various example embodiments, the timer 1414 may be configured to provide accurate periodical timing information to the interpreter 1410. It will be appreciated by a person skilled in the art that hardware-based and/or software-based timer solutions may be implemented in the charger controller 1404. For example, hardware-based solution may utilize a real-time clock in a form of an integrated circuit (IC) with embedded or external crystal oscillator. The timing information may then be accessed by microcontroller or microprocessor through a serial communication, such as I2C, SPI, RS232, and so on. For example, microcontroller or microprocessor may have embedded oscillators that can be utilized to form a software-based timer. In this case, a counter that has the same frequency with the internal oscillator may start incrementing until a configured period (e.g., 1 second, 1 millisecond, etc.) to trigger an interrupt. This timing information may thus be used to track the time utilized by the interpreter 1410.

In various example embodiments, an interface application 1412 allows modification of parameters in the database, including the metadata parameters and the charging parameters. In various example embodiments, the interface application 1412 may be embedded in the charging system 1400 itself by incorporating output peripheral, such as monitor, and input peripheral, such as button, potentiometer, keyboard, or the combination. In various other embodiments, the interface application 412 may be separate from the charging system 1400, for example, as a dedicated application configured to run on a computing device, such as a computer or a tablet. In this case, a user may configure parameters in the database 1408 by running the interface application and input the required parameters. The interface application may be communicatively coupled to the charger 1404 based on various wired or wireless communication protocols known in the art, such as Bluetooth, Ethernet, CAN, I2C, SPI, RS232, USB, and so on.

In conventional charging systems, charging strategies (or charging configurations) are pre-configured. For example, typically, a certain model or product of the charger carries a specific charging strategy with certain charging configuration. However, such a conventional method of implementing charging limits the charger to charging a specific type of battery because the charger is configured and fixed according to only one charging strategy. Although, there may have been disclosed an adjustable charger system 1300 that provide flexibility in adjusting the reference current and reference voltage as described hereinbefore with reference to FIG. 13, however, such an adjustable charger system 1300 is still only suitable for one type of battery, for example, limited to only a lead-acid battery or only a lithium-ion battery.

Accordingly, various example embodiments advantageously provide a battery charger technology that enables and/or enhances flexible implementation of charging strategies and charging configuration to support different sizes and types of batteries. Accordingly, the charger controller 1404 may be configured for different charging profiles by setting, changing or modifying the charging parameters in the database 1408. For better understanding, by way of examples only and without limitations, example charging profiles and example charging parameters in the corresponding charging profile blocks configured in the database 1408 for various example charging strategies according to various example embodiments of the present invention will now be described below.

### Multiple Blocks CCCV

FIGS. 17A and 17B depict an example IUIUa charging profile and the corresponding values of attributes of the charging parameters of the charging profile data, respectively, according to various example embodiments of the present invention. The example IUIUa charging profile is a more complex form of the CCCV charging strategy. In various example embodiments, the charging profile data may include two CPBs, with each CPB having current cut-off properties (i.e., includes a property parameter indicating current termination mode). For example, the first CPB may be executed until the battery current reduces to I_{ref_2} (i.e., upon meeting the current termination condition for this charging stage set by the current cutoff parameter of I_{ref_2} in the first CPB). The charging process may then proceed to the second CPB (being the next CPB according to its index) where the interpreter may refer to V_{ref_2} and I_{ref_2} as voltage and current reference. The charging process may then stop when the charging current is lower than Iₘᵢₙ (i.e., upon meeting the current termination condition for this charging stage set by the current cut-off parameter of Iₘᵢₙ in the second CPB).

FIGS. 18A and 18B depict an example five-step constant current charging profile and the corresponding values of attributes of the charging parameters of the charging profile data, respectively, according to various example embodiments of the present invention. The example five-step constant current charging profile is another more complex form of the CCCV charging strategy. For example, the five-step constant current can be configured by using the values of attributes as shown in the table in FIG. 18B. There are five voltage references (V_{ref_1-5}) and current references (I_{ref_1-5}). Accordingly, five charging profile blocks may be provided in the charging profile data for the example five-step constant current charging profile. For the property parameter, the voltage cut-off may be selected to proceed to the next block when the battery voltage reaches the voltage reference (V_{ref}) (i.e., upon meeting the voltage termination condition for the current charging stage set by the voltage cut-off parameter in the respective CPB). At the last CPB, the charging process may stop when the voltage termination condition set by the voltage cut-off parameter in the last CPB is satisfied).

### Wa and W0Wa Curve

FIGS. 19A and 19B depict an example Wa charging profile with repeating equalizing stage and the corresponding values of attributes of the charging parameters of the charging profile data, respectively, according to various example embodiments of the present invention. The charging profile data has multiple CPBs with different charging types, namely, the slope charging type (e.g., taper or boost charging type) and the constant charging type. To implement the Wa charging profile, four CPBs are included in the charging profile data. The first two CPBs indicates the taper charging type for the corresponding two charging stages where the charging current is decreasing based on increasing battery voltage. In the taper charging type, according to various example embodiments, the current reference may be determined using a linear equation based on real-time battery voltage, current, and voltage setting, such as based on the following example equation:

$${I}_{ref} = {I}_{0} - ( \frac{( {I}_{0} - {I}_{1} ) \times ( {V}_{bat} - {V}_{0} )}{( {V}_{1} - {V}_{0} )} ) {V}_{bat}$$

where,
   I_{ref} current reference
   V_{bat} battery voltage
   V₀ CPB.voltage_0
   I₀ CPB.current_0
   V₁ CPB.voltage_1
   I₁ CPB.current_1

In the charging profile data, the third CPB corresponds to a pause charging stage where the charging current is set to zero for a specific time period T_{off}. In this case, the charging block type may be set to constant and voltage and current reference may both be set to zero. After T_{off} is finished, the fourth CPB is executed. The fourth CPB indicates the taper charging type with an index loop parameter and a voltage cut-off property parameter. For example, the voltage cut-off decides at what battery voltage level the charging process proceeds to the next CPB for the next charging stage. The index loop property parameter enables the charging loop in the equalizing stage. For example, as shown in FIG. 19B, the index_loop parameter in CPB_3 may be set to a value of 2, thereby indicating that the next CPB in the charging process is CPB_2 (i.e., having an associated index of 2) after the battery voltage reaches V_{ref_5} (i.e., upon meeting the voltage termination condition set by the voltage cut-off parameter in CPB_3). Accordingly, in the example Wa charging profile, the repeating equalizing stages can be implemented by using CPB_2 and CPB_3.

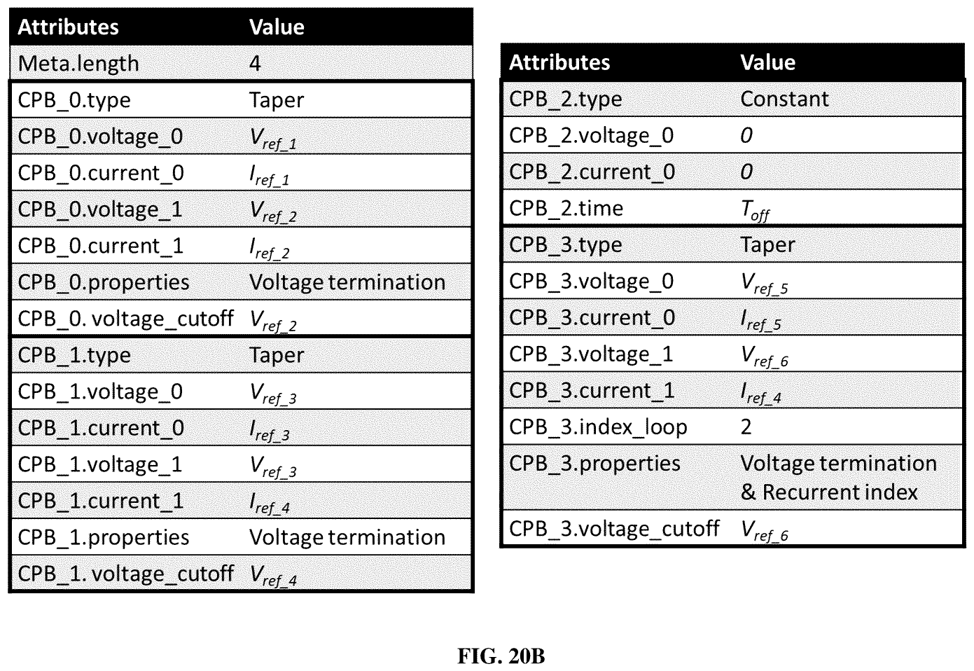

FIGS. 20A and 20B depict an example W0Wa charging profile with repeating equalizing stages and the corresponding values of attributes of the charging parameters of the charging profile data, respectively, according to various example embodiments of the present invention. Similar to the Wa charging profile, the W0Wa charging profile can be implemented by using four charging profile blocks as shown in FIG. 20B. The primary difference between the example Wa charging profile and the example W0Wa charging profile is the voltage and current reference values. The type and property charging parameters can be the same as the Wa charging profile, and thus need not be repeated for clarity and conciseness.

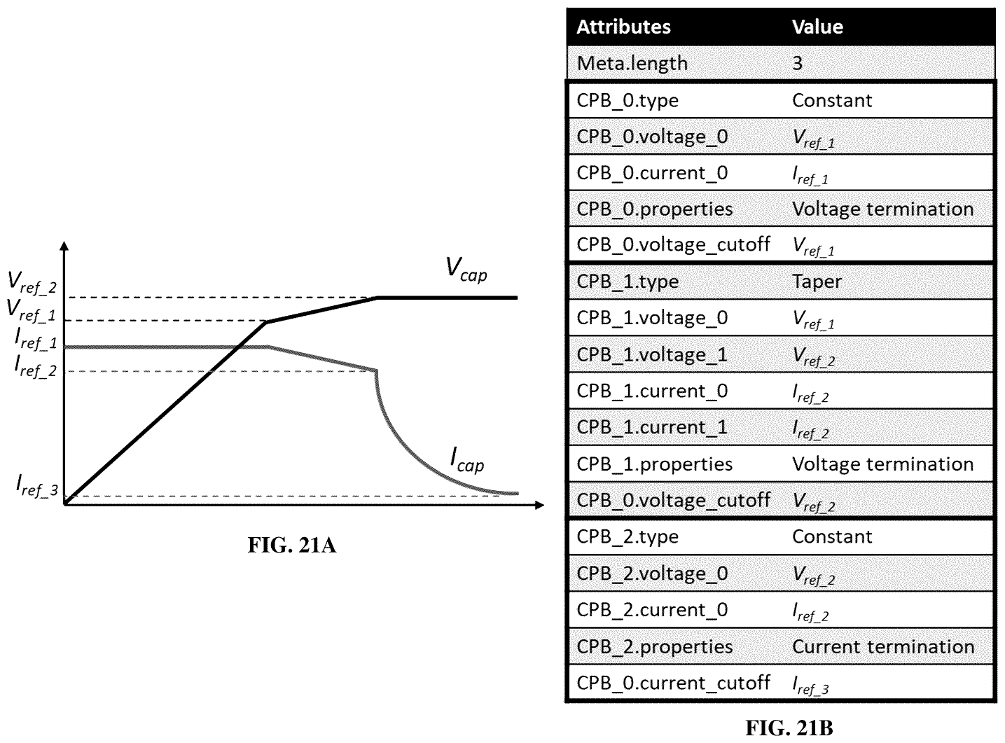

FIGS. 21A and 21B depict one of charging profile example for supercapacitor and the corresponding values of attributes of the charging parameters of the charging profile data, respectively, according to various example embodiments of the present invention. The example supercapacitor charging profile is a combination of the CCCV charging strategy and taper charging strategy. In various example embodiments, the charging profile data may include three CPBs, with first two CPBs having voltage cut-off properties (i.e., includes a property parameter indicating voltage termination mode) and third CPB having current cut-off properties (i.e., includes a property parameter indicating current termination mode). For example, the first CPB starts the charging with constant current charging profile and may be executed until the battery voltage increases to V_{ref_1} (i.e., upon meeting the voltage termination condition for this charging stage set by the voltage cutoff parameter of V_{ref_1} in the first CPB). The charging process may then proceed to the second CPB (being the next CPB according to its index) where the interpreter uses taper charging type and may refer to (V_{ref_1}, V_{ref_2}) and (I_{ref_1}, I_{ref_2}) as voltage and current references. The second CPB may be executed until the battery voltage increases to V_{ref_2} (i.e., upon meeting the voltage termination condition for this charging stage set by the voltage cutoff parameter of V_{ref_2} in the second CPB). The charging process may then proceed to the third CPB (being the next CPB according to its index) where constant voltage charging profile is executed and the charging process may then stop when the charging current is lower than I_{ref_3} (i.e., upon meeting the current termination condition for this charging stage set by the current cut-off parameter of I_{ref_3} in the third CPB).

Accordingly, for illustration purpose, flexible implementation of a number of different example charging profiles have been described to demonstrate the efficiency and/or effectiveness of the method of charging a rechargeable battery according to various example embodiments of the present invention, and more particular, enabling and/or enhancing flexibility in implementing charging strategies for supporting various (different) battery sizes and types. In various example embodiments, the database 1408 and the interpreter runtime may be expanded with more attributes for supporting various charging strategies as appropriate, such as but not limited to, temperature considerations.

It will be appreciated by a person skilled in the art that the present battery charger technology may be applied to any type of chargers as appropriate, such as wired or wireless chargers, capable of charging electrochemical cells (e.g., batteries, supercapacitors, and so on). By way of examples only and without limitations, the present battery charger technology may be applied to low power applications, such as mobile phones, cameras, tablets, or any mobile electronic devices, as well as high power applications, such as electric vehicles, automated guided vehicles, robots, home appliances, or power tools. It will be appreciated by a person skilled in the art that the present battery charger technology is also not limited to any particular converter topology, such as, buck, boost, buck-boost, flyback, half- or full-bridge rectifier, or a combination thereof.

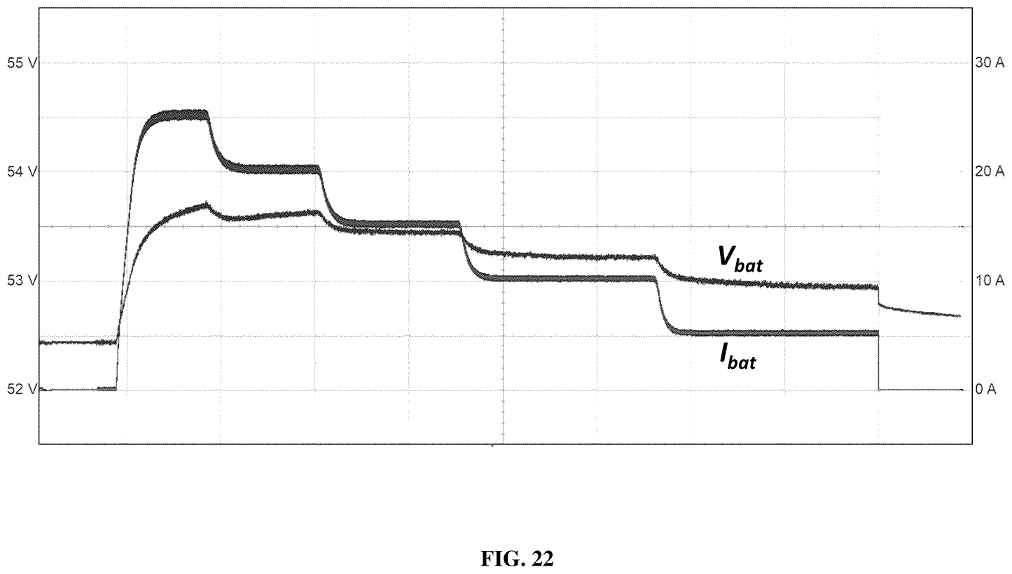

FIG. 22 depicts a graph showing the implementation of the five-step constant current charging profile obtained using the charging system 1400 according to various example embodiments of the present invention. There are five current references starting from 25A down to 5A with a 5A decrement at each step, and the time cut-off property is used. Accordingly, FIG. 22 demonstrates that the method of charging a rechargeable battery according to various example embodiments of the present invention advantageously performs efficiency and effectively, while enabling and/or enhancing flexibility in implementing charging strategies for supporting various (different) battery sizes and types.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-30. (canceled)

31. A method of charging a rechargeable electrical energy storage, comprising:
receiving, from a memory, for each of a plurality of charging stages of a charging profile for charging the rechargeable electrical energy storage, a set of charging parameters associated with the charging stage; and
controlling, for said each of the plurality of charging stages of the charging profile, a charger coupled to the rechargeable electrical energy storage based on the corresponding set of charging parameters received for charging the rechargeable electrical energy storage, wherein
the memory comprises charging profile data defining the charging profile for charging the rechargeable electrical energy storage, the charging profile data comprising a plurality of charging profile blocks defining the plurality of charging stages of the charging profile, respectively, wherein each of the plurality of charging profile blocks comprises a plurality of predefined charging parameter data fields, each predefined charging parameter data field of the charging profile block being configurable with a corresponding charging parameter for defining the charging stage corresponding to the charging profile block, wherein the plurality of predefined charging parameter data fields of the charging profile block further comprises an index parameter field configured to store an index parameter corresponding to an index of a charging profile block of the plurality of charging profile blocks based on which the charging of the rechargeable electrical energy storage is to be performed at a next charging stage of the charging profile, wherein the index parameter is an index loop parameter indicating the index of a preceding charging profile block of the plurality of charging profile blocks with respect to the charging profile block for forming a charging loop, and
for said each of the plurality of charging stages of the charging profile, the set of charging parameters associated with the charging stage is obtained from the corresponding charging profile block of the charging profile data.

32. The method according to claim 31, wherein said each predefined charging parameter data field of the charging profile block is configurable with the corresponding charging parameter based on a corresponding user data input received via a data input user interface configured for receiving a user data input for defining the charging profile for charging the rechargeable electrical energy storage.

33. The method according to claim 31, wherein, for said each of the plurality of charging profile blocks, the plurality of predefined charging parameter data fields of the charging profile block comprises:
a first reference voltage parameter data field configured to store a first reference voltage parameter corresponding to a first reference voltage value for the charging stage corresponding to the charging profile block, and/or
a first reference current parameter data field configured to store a first reference current parameter corresponding to a first reference current value for the charging stage corresponding to the charging profile block; and/or
a cut-off current parameter data field configured to store a cut-off current parameter corresponding to a cut-off current value for the charging stage corresponding to the charging profile block; and/or
a cut-off voltage parameter data field configured to store a cut-off voltage parameter corresponding to a cut-off voltage value for the charging stage corresponding to the charging profile block.

34. The method according to claim 31, wherein, for said each of the plurality of charging profile blocks, the plurality of predefined charging parameter data fields of the charging profile block further comprises:
a second reference voltage parameter data field configured to store a second reference voltage parameter corresponding to a second reference voltage value for the charging stage corresponding to the charging profile block, and/or
a second reference current parameter data field configured to store a second reference current parameter corresponding to a second reference current value for the charging stage corresponding to the charging profile block, wherein
the first reference voltage value and the second reference voltage value define a start reference voltage value and an end reference voltage value, respectively, for the charging stage corresponding to the charging profile block, and
the first reference current value and the second reference current value define a start reference current value and an end reference current value, respectively, for the charging stage corresponding to the charging profile block.

35. The method according to claim 34, wherein, for said each of the plurality of charging profile blocks, the plurality of predefined charging parameter data fields of the charging profile block further comprises a charging type parameter data field configured to store a charging type parameter corresponding to a charging type for the charging stage corresponding to the charging profile block.

36. The method according to claim 35, wherein
for said each of the plurality of charging stages, the corresponding set of charging parameters received associated with the charging stage comprises the charging type parameter, and
said controlling, for said each of the plurality of charging stages, the charger comprises:
generating, for the charging stage, an output reference voltage value and an output reference current value based on the charging type parameter in the corresponding set of charging parameters received associated with the charging stage; and
supplying, for the charging stage, the output reference voltage value and the output reference current value generated to the charger.

37. The method according to claim 36, wherein
for at least a first charging stage of the plurality of charging stages, the corresponding set of charging parameters received further comprises the first reference voltage parameter and the first reference current parameter, and the charging type parameter of the corresponding set of charging parameters received corresponds to a constant charging type for the first charging stage, and
said controlling the charger comprises:
generating, for the first charging stage, the output reference voltage value and the output reference current value based on the charging type parameter, the first reference voltage parameter and the first reference current parameter in the corresponding set of charging parameters received associated with the first charging stage; and
supplying, for the first charging stage, the output reference voltage value and the output reference current value generated to the charger and wherein
for at least a second charging stage of the plurality of charging stages, the corresponding set of charging parameters received further comprises the first reference voltage parameter, the first reference current parameter, the second reference voltage parameter and the second reference voltage parameter, and the charging type parameter of the corresponding set of charging parameters received corresponds to a slope charging type for the second charging stage, and
said controlling the charger comprises:
generating, for the second charging stage, the output reference voltage value and the output reference current value based on the charging type parameter, the first reference voltage parameter, the first reference current parameter, the second reference voltage parameter, and the second reference voltage parameter in the corresponding set of charging parameters received associated with the second charging stage; and
supplying, for the second charging stage, the output reference voltage value and the output reference current value generated to the charger.

38. The method according to claim 36, wherein
each of the plurality of charging profile blocks of the charging profile data is associated with a corresponding index,
for the first or second charging stage, the corresponding set of charging parameters received further comprises the index parameter, and
said controlling the charger comprises controlling, for the next charging stage of the charging profile, the charger to perform the charging of the rechargeable electrical energy storage based on the charging profile block of the plurality of charging profile blocks having the associated index corresponding to the index parameter.

39. The method according to claim 31, wherein said controlling, for said each of the plurality of charging stages, the charger coupled to the rechargeable electrical energy storage, is further based on timing information generated by a timer.

40. A charger controller for charging a rechargeable electrical energy storage, the charger controller comprising:
a memory; and
at least one processor coupled to the memory and configured to:
receive, from the memory, for each of a plurality of charging stages of a charging profile for charging the rechargeable electrical energy storage, a set of charging parameters associated with the charging stage; and
control, for said each of the plurality of charging stages of the charging profile, a charger coupled to the rechargeable electrical energy storage based on the corresponding set of charging parameters received for charging the rechargeable electrical energy storage, wherein
the memory comprises charging profile data defining the charging profile for charging the rechargeable electrical energy storage, the charging profile data comprising a plurality of charging profile blocks defining the plurality of charging stages of the charging profile, respectively, wherein each of the plurality of charging profile blocks comprises a plurality of predefined charging parameter data fields, each predefined charging parameter data field of the charging profile block being configurable with a corresponding charging parameter for defining the charging stage corresponding to the charging profile block, wherein the plurality of predefined charging parameter data fields of the charging profile block further comprises an index parameter field configured to store an index parameter corresponding to an index of a charging profile block of the plurality of charging profile blocks based on which the charging of the rechargeable electrical energy storage is to be performed at a next charging stage of the charging profile, wherein the index parameter is an index loop parameter indicating the index of a preceding charging profile block of the plurality of charging profile blocks with respect to the charging profile block for forming a charging loop, and
for said each of the plurality of charging stages of the charging profile, the set of charging parameters associated with the charging stage is obtained from the corresponding charging profile block of the charging profile data.

41. The charger controller according to claim 40, wherein said each predefined charging parameter data field of the charging profile block is configurable with the corresponding charging parameter based on a corresponding user data input received via a data input user interface configured for receiving a user data input for defining the charging profile for charging the rechargeable electrical energy storage.

42. The charger controller according to claim 40, wherein, for said each of the plurality of charging profile blocks, the plurality of predefined charging parameter data fields of the charging profile block comprises:
a first reference voltage parameter data field configured to store a first reference voltage parameter corresponding to a first reference voltage value for the charging stage corresponding to the charging profile block, and/or
a first reference current parameter data field configured to store a first reference current parameter corresponding to a first reference current value for the charging stage corresponding to the charging profile block; and/or
a cut-off current parameter data field configured to store a cut-off current parameter corresponding to a cut-off current value for the charging stage corresponding to the charging profile block; and/or
a cut-off voltage parameter data field configured to store a cut-off voltage parameter corresponding to a cut-off voltage value for the charging stage corresponding to the charging profile block.

43. The charger controller according to claim 40, wherein, for said each of the plurality of charging profile blocks, the plurality of predefined charging parameter data fields of the charging profile block further comprises:
a second reference voltage parameter data field configured to store a second reference voltage parameter corresponding to a second reference voltage value for the charging stage corresponding to the charging profile block, and/or
a second reference current parameter data field configured to store a second reference current parameter corresponding to a second reference current value for the charging stage corresponding to the charging profile block, wherein
the first reference voltage value and the second reference voltage value define a start reference voltage value and an end reference voltage value, respectively, for the charging stage corresponding to the charging profile block, and
the first reference current value and the second reference current value define a start reference current value and an end reference current value, respectively, for the charging stage corresponding to the charging profile block.

44. The charger controller according to claim 43, wherein, for said each of the plurality of charging profile blocks, the plurality of predefined charging parameter data fields of the charging profile block further comprises a charging type parameter data field configured to store a charging type parameter corresponding to a charging type for the charging stage corresponding to the charging profile block.

45. The charger controller according to claim 44, wherein
for said each of the plurality of charging stages, the corresponding set of charging parameters received associated with the charging stage comprises the charging type parameter, and
said controlling, for said each of the plurality of charging stages, the charger comprises:
generating, for the charging stage, an output reference voltage value and an output reference current value based on the charging type parameter in the corresponding set of charging parameters received associated with the charging stage; and
supplying, for the charging stage, the output reference voltage value and the output reference current value generated to the charger.

46. The charger controller according to claim 45, wherein
for at least a first charging stage of the plurality of charging stages, the corresponding set of charging parameters received further comprises the first reference voltage parameter and the first reference current parameter, and the charging type parameter of the corresponding set of charging parameters received corresponds to a constant charging type for the first charging stage, and
said controlling the charger comprises:
generating, for the first charging stage, the output reference voltage value and the output reference current value based on the charging type parameter, the first reference voltage parameter and the first reference current parameter in the corresponding set of charging parameters received associated with the first charging stage; and
supplying, for the first charging stage, the output reference voltage value and the output reference current value generated to the charger and wherein
for at least a second charging stage of the plurality of charging stages, the corresponding set of charging parameters received further comprises the first reference voltage parameter, the first reference current parameter, the second reference voltage parameter and the second reference voltage parameter, and the charging type parameter of the corresponding set of charging parameters received corresponds to a slope charging type for the second charging stage, and
said controlling the charger comprises:
generating, for the second charging stage, the output reference voltage value and the output reference current value based on the charging type parameter, the first reference voltage parameter, the first reference current parameter, the second reference voltage parameter, and the second reference voltage parameter in the corresponding set of charging parameters received associated with the second charging stage; and
supplying, for the second charging stage, the output reference voltage value and the output reference current value generated to the charger.

47. The charger controller according to claim 45, wherein
each of the plurality of charging profile blocks of the charging profile data is associated with a corresponding index,
for the first or second charging stage, the corresponding set of charging parameters received further comprises the index parameter, and
said controlling the charger comprises controlling, for the next charging stage of the charging profile, the charger to perform the charging of the rechargeable electrical energy storage based on the charging profile block of the plurality of charging profile blocks having the associated index corresponding to the index parameter.

48. The charger controller according to claim 31, wherein said controlling, for said each of the plurality of charging stages, the charger coupled to the rechargeable electrical energy storage, is further based on timing information generated by a timer.

49. A charging system for charging a rechargeable electrical energy storage, the charging system comprising:
a charger coupled or couplable to the rechargeable electrical energy storage; and
a charger controller according to claim 45 communicatively coupled to the charger and configured to control the charger for charging the rechargeable electrical energy storage.

50. A computer program product, embodied in one or more computer-readable storage mediums, comprising instructions executable by at least one processor to perform the method of charging a rechargeable electrical energy storage according to claim 31.
